(19) United States
(12) Patent Application Publication
(10) Pub. No.: US 2015/0023432 A1
(43) Pub. Date: Jan. 22, 2015

(54) SCALABLE VIDEO-ENCODING METHOD AND APPARATUS, AND SCALABLE VIDEO-DECODING METHOD AND APPARATUS

(71) Applicant: SAMSUNG ELECTRONICS CO., LTD., Gyeonggi-do (KR)

(72) Inventors: Byeong-doo Choi, Siheung-si (KR); Il-koo Kim, Osan-si (KR); Chan-yul Kim, Bucheon-si (KR); Young-o Park, Seoul (KR); Jeong-hoon Park, Seoul (KR); Tammy Lee, Seoul (KR)

(73) Assignee: SAMSUNG ELECTRONICS CO., LTD., Suwon-si (KR)

(21) Appl. No.: 14/384,992

(22) PCT Filed: Mar. 12, 2013
(86) PCT No.: PCT/KR2013/001973

§ 371 Date: Sep. 12, 2014

Related U.S. Application Data
(60) Provisional application No. 61/609,503, filed on Mar. 12, 2012.

(30) Foreign Application Priority Data
Jul. 27, 2012 (KR) 10-2012-0044670

(51) Int. Cl. H04N 19/30; H04N 19/46

(52) U.S. Cl. CPC H04N 19/00424; H04N 19/00545
USPC 375/240.26

(57) ABSTRACT

Disclosed are a scalable video encoding method and apparatus and a scalable video decoding method and apparatus. The scalable video encoding method adds, into a bitstream, table index information representing one of a plurality of scalable extension type information tables in which available combinations of a plurality of scalable extension types are specified and layer index information representing the scalable extension type of the encoded video among combinations of a plurality of scalable extension types included in a scalable extension type information table.

### TECHNICAL FIELD

The present invention relates to a scalable video encoding method and a scalable video encoding apparatus for implementing the same, and a scalable video decoding method and a scalable video decoding apparatus for implementing the same.

### BACKGROUND ART

Generally, video data is decoded by a codec based on data compression standard (for example, moving picture expert group (MPEG) standard), and then is stored in a bitstream form in an information storage medium or is transmitted through a communication channel.

Scalable video coding (SVC) is a video compression method that appropriately adjusts an amount of information in correspondence with various communication networks and terminals and transmits the information. The SVC provides a video coding method that adaptively provides a service to various transmission networks and various receiving terminals by using one video stream.

Recently, as three-dimensional (3D) multimedia equipment and 3D multimedia content are propagated, multiview video coding technology for 3D video coding is being widely spread.

In a related art scalable video coding or multiview video coding, a video is encoded according to a limited coding method, based on a macro block of a predetermined size.

### DETAILED DESCRIPTION OF THE INVENTION

### Technical Problem

The present invention provides a scalable video encoding method and apparatus which efficiently transmit scalable extension type information of a video when scalably encoding a video into various types as in spatial, temporal, qualitative, and multiview scalable extension.

The present invention also provides a scalable video decoding method and apparatus which obtains scalable extension type information of an image decoded from a bitstream to decode the video.

### Technical Solution

According to an aspect of the present invention, information representing a scalable extension type is added into a reserved region of a network abstraction layer.

### Advantageous Effects

According to aspects of the exemplary embodiments of the present invention, by adding information representing a scalable extension type into a reserved region of a network abstraction layer which is ready for future extension, various scalable extension type information applied to video coding is compatible with various video compression methods, and can be efficiently transmitted.

### DESCRIPTION OF THE DRAWINGS

FIG. 1 is a block diagram of a scalable video encoding apparatus according to an exemplary embodiment of the present invention.

FIG. 2 is a block diagram illustrating a configuration of a video encoding unit 110 of FIG. 1.

FIG. 3A is a diagram illustrating an example of a temporal scalable video.

FIG. 3B is a diagram illustrating an example of a spatial scalable video.

FIG. 3C is a diagram illustrating an example of a temporal and multiview scalable video.

FIG. 4 is a diagram in which a video encoding process and a video decoding process according to an exemplary embodiment of the present invention are hierarchically classified.

FIG. 5 is a diagram illustrating an NAL unit according to an exemplary embodiment of the present invention.

FIG. 6 is a diagram illustrating a scalable extension type information table according to an embodiment of the present invention.

FIG. 7 is a diagram illustrating an NAL unit according to another embodiment of the present invention.

FIG. 8 is a diagram illustrating scalable extension type information which a first sub-layer index (Sub-LID1) 705 and a second sub-layer index (Sub-LID1) 706 indicate, based on a SET 704 of the NAL unit of FIG. 7.

FIG. 9 is a flowchart illustrating a scalable video encoding method according to an exemplary embodiment of the present invention.

FIG. 10 is a block diagram of a scalable video decoding apparatus according to an exemplary embodiment of the present invention.

FIG. 11 is a flowchart illustrating a scalable video decoding method according to an exemplary embodiment of the present invention.

FIG. 12 illustrates a block diagram of a video encoding apparatus which performs video prediction based on a coding unit based on a tree structure, according to an exemplary embodiment of the present invention.

FIG. 13 illustrates a block diagram of a video decoding apparatus which performs video prediction based on a coding unit based on a tree structure, according to an exemplary embodiment of the present invention.

FIG. 14 illustrates a concept of a coding unit according to an exemplary embodiment of the present invention.

FIG. 15 illustrates a block diagram of a video encoding unit based on a coding unit according to an exemplary embodiment of the present invention.

FIG. 16 illustrates a block diagram of a video decoding unit based on a coding unit according to an exemplary embodiment of the present invention.

FIG. 17 illustrates a coding unit according to depths and a partition according to an exemplary embodiment of the present invention.

FIG. 18 illustrates a relationship between a coding unit and a transformation unit, according to an exemplary embodiment of the present invention.

FIG. 19 illustrates encoding information of coding units corresponding to a coded depth, according to an exemplary embodiment of the present invention.

FIG. 20 illustrates a depth-based coding unit according to an exemplary embodiment of the present invention.

FIGS. 21 to 23 illustrate a relationship between a coding unit, a prediction unit, and a transformation unit, according to an exemplary embodiment of the present invention.

FIG. 24 illustrates a relationship between a coding unit, a prediction unit, and a transformation unit, based on encoding mode information of Table 2.

### BEST MODE

A scalable video encoding method according to an embodiment of the present invention includes: encoding a video according to at least one of a plurality of scalable extension types to generate a bitstream; and adding scalable extension type information, representing a scalable extension type of the encoded video, into the bitstream, wherein the scalable extension type information includes table index information, representing one of a plurality of scalable extension type information tables in which available combinations of a plurality of scalable extension types are specified, and layer index information representing the scalable extension type of the encoded video among combinations of a plurality of scalable extension types included in a scalable extension type information table.

A scalable video encoding method according to another embodiment of the present invention includes: encoding a video according to at least one of a plurality of scalable extension types to generate a bitstream; and adding scalable extension type information, representing a scalable extension type of the encoded video, into the bitstream, wherein, the scalable extension type information includes combination scalable index information and pieces of sub-layer index information, the combination scalable index information represents which of a plurality of scalable extension layers the pieces of sub-layer index information are mapped to, and each of the pieces of sub-layer index information represents a specific scalable extension type of the encoded video.

A scalable video decoding method according to an embodiment of the present invention includes: receiving and parsing a bitstream of an encoded video to obtain a scalable extension type of the encoded video among a plurality of scalable extension types; and decoding the encoded video, based on the obtained scalable extension type, wherein the scalable extension type information includes table index information, representing one of a plurality of scalable extension type information tables in which available combinations of a plurality of scalable extension types are specified, and layer index information representing the scalable extension type of the encoded video among combinations of a plurality of scalable extension types included in a scalable extension type information table.

A scalable video decoding method according to another embodiment of the present invention includes: receiving and parsing a bitstream of an encoded video to obtain a scalable extension type of the encoded video among a plurality of scalable extension types; and decoding the encoded video, based on the obtained scalable extension type, wherein, the scalable extension type information includes combination scalable index information and pieces of sub-layer index information, the combination scalable index information represents which of a plurality of scalable extension layers the pieces of sub-layer index information are mapped to, and each of the pieces of sub-layer index information represents a specific scalable extension type of the encoded video.

A scalable video encoding apparatus according to an embodiment of the present invention includes: a video coding unit that encodes a video according to at least one of a plurality of scalable extension types to generate a bitstream; and an output unit that adds scalable extension type information, representing a scalable extension type of the encoded video, into the bitstream, wherein the scalable extension type information includes table index information, representing one of a plurality of scalable extension type information tables in which available combinations of a plurality of scalable extension types are specified, and layer index information representing the scalable extension type of the encoded video among combinations of a plurality of scalable extension types included in a scalable extension type information table.

A scalable video encoding apparatus according to another embodiment of the present invention includes: a video coding unit that encodes a video according to at least one of a plurality of scalable extension types to generate a bitstream; and an output unit that adds scalable extension type information, representing a scalable extension type of the encoded video, into the bitstream, wherein, the scalable extension type information includes combination scalable index information and pieces of sub-layer index information, the combination scalable index information represents which of a plurality of scalable extension layers the pieces of sub-layer index information are mapped to, and each of the pieces of sub-layer index information represents a specific scalable extension type of the encoded video.

A scalable video decoding apparatus according to an embodiment of the present invention includes: a receiving unit that receives and parses a bitstream of an encoded video to obtain a scalable extension type of the encoded video among a plurality of scalable extension types; and a decoding unit that decodes the encoded video, based on the obtained scalable extension type, wherein the scalable extension type information includes table index information, representing one of a plurality of scalable extension type information tables in which available combinations of a plurality of scalable extension types are specified, and layer index information representing the scalable extension type of the encoded video among combinations of a plurality of scalable extension types included in a scalable extension type information table.

A scalable video decoding apparatus according to another embodiment of the present invention includes: a receiving unit that receives and parses a bitstream of an encoded video to obtain a scalable extension type of the encoded video among a plurality of scalable extension types; and a decoding unit that decodes the encoded video, based on the obtained scalable extension type, wherein, the scalable extension type information includes combination scalable index information and pieces of sub-layer index information, the combination scalable index information represents which of a plurality of scalable extension layers the pieces of sub-layer index information are mapped to, and each of the pieces of sub-layer index information represents a specific scalable extension type of the encoded video.

### MODE OF THE INVENTION

Hereinafter, embodiments of the present invention will be described in detail with reference to the accompanying drawings.

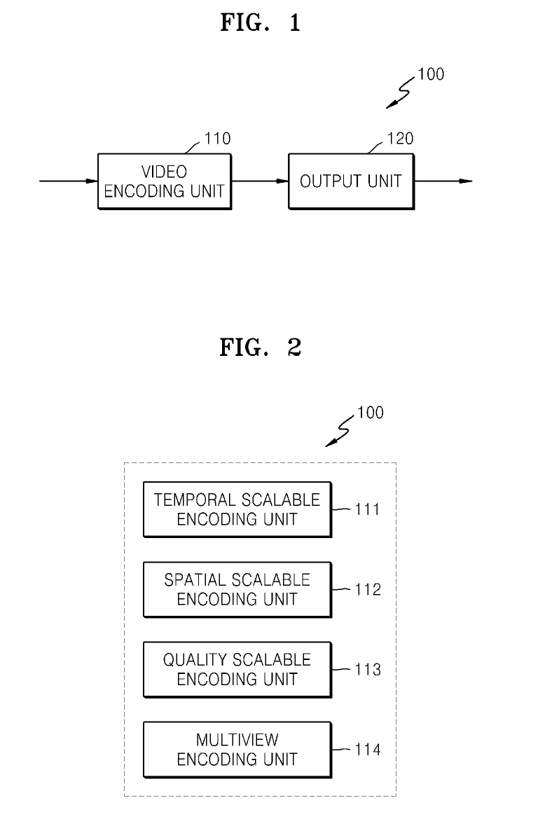

FIG. 1 is a block diagram of a scalable video encoding apparatus 100 according to an exemplary embodiment of the present invention.

Referring to FIG. 1, the scalable video encoding apparatus 100 according to an embodiment of the present invention includes a video encoding unit 110 and an output unit 120. A video sequence, such as a 2D video, a 3D video, and a multiview video, may be input to the scalable video encoding apparatus 100.

In order to provide an optimal service under various network environments and various terminals, the scalable video encoding apparatus 100 constructs a bitstream including a spatial resolution, quality, a frame rate, and a multiview video to scalably generate the bitstream so that the various terminals receive and restore the bitstream according to an ability of each of the various terminals, and outputs the bitstream. That is, the video encoding unit 110 encodes an input video according to various scalable extension types to generate a scalable video bitstream, and outputs the scalable video bitstream. The scalable extension type includes temporal, spatial, qualitative, and multiview scalability.

When a video bitstream is capable of being divided into valid sub-streams according to an ability of a receiving terminal, the video bitstream is scalable. For example, a spatial scalable bitstream includes a sub-stream having a resolution which is lowered compared to the original resolution, and a temporal scalable bitstream includes a sub-stream which is lowered compared to the original frame rate. Also, a qualitative scalable bitstream includes a sub-stream which has the same spatio-temporal resolution as that of a whole bitstream, but has a lower fidelity or signal-to-noise (SNR) than that of the whole bitstream. A multiview scalable bitstream includes different-view sub-streams in one bitstream. For example, a stereoscopic video includes a left video and a right video.

Different scalable extension types may be combined with each other. In this case, a scalable video bitstream may include an encoded video having different spatio-temporal resolutions, different qualities, and different views.

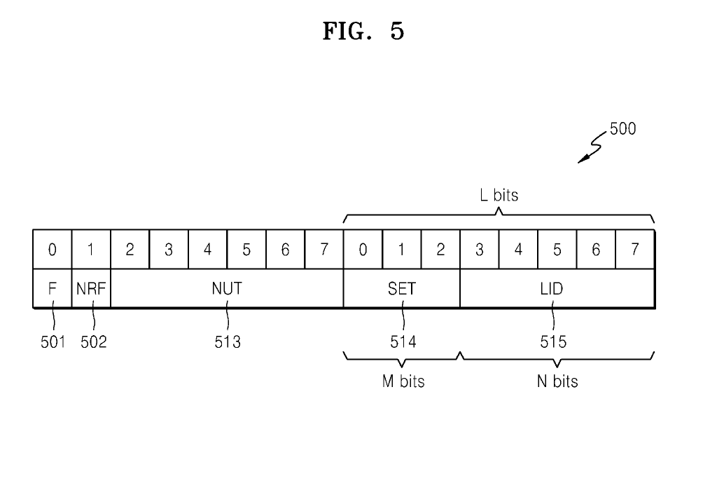

The output unit 120 adds scalable extension type information representing a scalable extension type of an encoded video into a bitsteam, and outputs the scalable extension type information. The scalable extension type information added by the output unit 120 will be described in detail with reference to FIGS. 5 to 8.

FIG. 2 is a block diagram illustrating a configuration of the video encoding unit 110 of FIG. 1.

Referring to FIG. 2, the video encoding unit 110 includes a temporal scalable encoding unit 111, a spatial scalable encoding unit 112, a quality scalable encoding unit 113, and a multiview encoding unit 114.

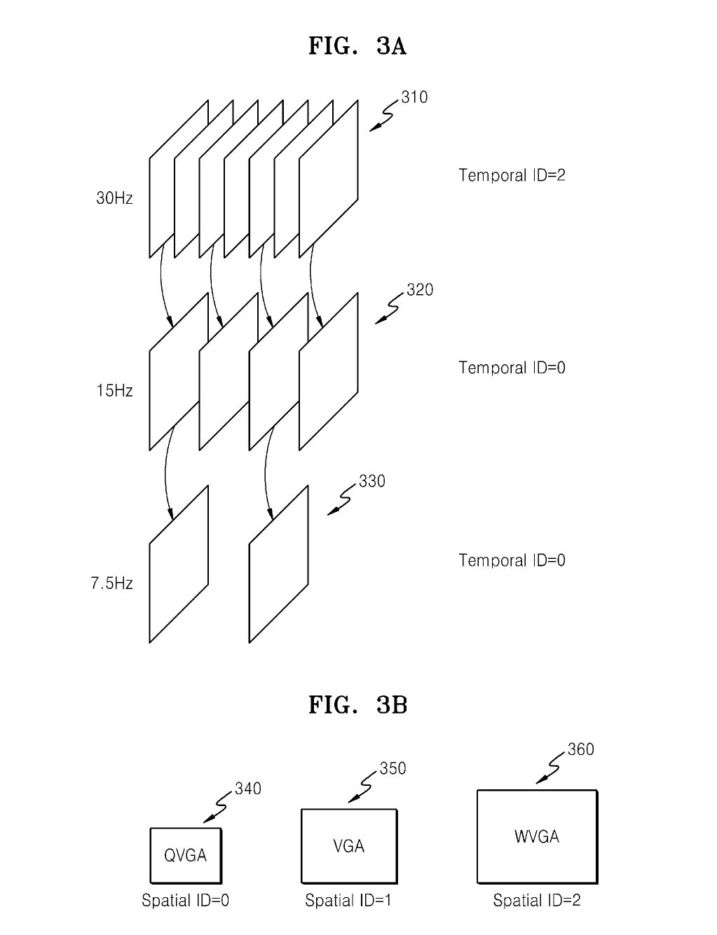

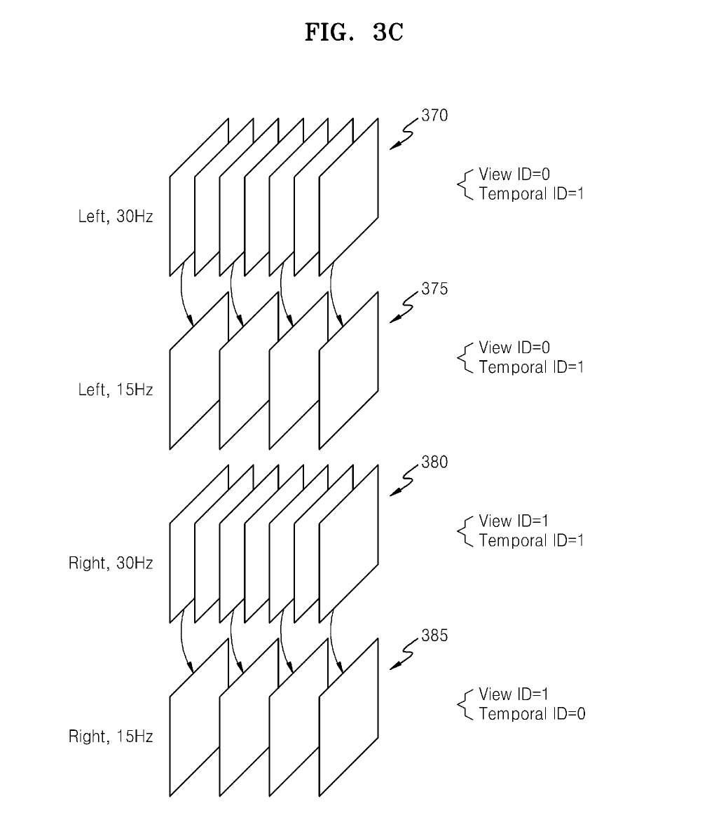

The temporal scalable encoding unit 111 temporally, scalably encodes an input video to generate a temporal scalable bitstream, and outputs the temporal scalable bitstream. The temporal scalable bitstream includes sub-streams having different frame rates in one bitstream. For example, referring to FIG. 3A, the temporal scalable encoding unit 111 may encode videos of a first temporal layer 330 having a frame rate of 7.5 Hz to generate a bitstream of the first temporal layer 330 that is a base layer. In this case, temporal ID=0 may be added into a bitstream, obtained by encoding the video of the first temporal layer 330, as temporal scalable extension type information representing a video included in the first temporal layer 330. Similarly, the temporal scalable encoding unit 111 may encode videos of a second temporal layer 320 having a frame rate of 15 Hz to generate a bitstream of the second temporal layer 320 that is an enhancement layer. In this case, temporal ID=1 may be added into a bitstream, obtained by encoding the video of the second temporal layer 320, as temporal scalable extension type information representing a video included in the second temporal layer 320. Similarly, the temporal scalable encoding unit 111 may encode videos of a third temporal layer 310 having a frame rate of 30 Hz to generate a bitstream of the third temporal layer 310 that is an enhancement layer. In this case, temporal ID=2 may be added into a bitstream, obtained by encoding the video of the third temporal layer 310, as temporal scalable extension type information representing a video included in the third temporal layer 310. In encoding videos included in the first to third temporal layers 330, 320 and 310, the temporal scalable encoding unit 111 may perform coding by using a correlation between the temporal layers. Also, the temporal scalable encoding unit 111 may generate a temporal scalable bitstream by using motion compensated temporal filtering or hierarchical B-pictures.

The spatial scalable encoding unit 112 spatially, scalably encodes an input video to generate a spatial scalable bitstream, and outputs the spatial scalable bitstream. The spatial scalable bitstream includes sub-streams having different resolutions in one bitstream. For example, referring to FIG. 3B, the spatial scalable encoding unit 112 may encode videos of a first spatial layer 340 having a resolution of QVGA to generate a bitstream of the first spatial layer 340 that is a base layer. In this case, Spatial ID=0 may be added into a bitstream, obtained by encoding the video of the first spatial layer 340, as spatial scalable extension type information representing a video included in the first spatial layer 340. Similarly, the spatial scalable encoding unit 112 may encode videos of a second spatial layer 350 having a resolution of VGA to generate a bitstream of the second spatial layer 350 that is an enhancement layer. In this case, Spatial ID=1 may be added into a bitstream, obtained by encoding the video of the second spatial layer 350, as spatial scalable extension type information representing a video included in the second spatial layer 350. Similarly, the spatial scalable encoding unit 112 may encode videos of a third spatial layer 360 having a resolution of WVGA to generate a bitstream of the third spatial layer 360 that is an enhancement layer. In this case, Spatial ID=2 may be added into a bitstream, obtained by encoding the video of the third spatial layer 360, as spatial scalable extension type information representing a video included in the third spatial layer 360. In encoding videos included in the first to third spatial layers 340, 350 and 360, the spatial scalable encoding unit 112 may perform coding by using a correlation between the spatial layers.

The quality scalable encoding unit 113 qualitatively, scalably encodes an input video to generate a quality scalable bitstream, and outputs the quality scalable bitstream. The quality scalable encoding unit 113 may qualitatively, scalably encode an input video in a coarse-grained scalability (CGS) method, a medium-grained scalability (MGS) method, or a fine-grained scalability (FGS) method. The quality scalable encoding unit 113 may set Quality ID=0 as quality scalable extension type information for identifying a bitstream of a first quality layer based on the CGS method, Quality ID=1 as quality scalable extension type information for identifying a bitstream of a second quality layer based on the MGS method, and Quality ID=2 as quality scalable extension type information for identifying a bitstream of a third quality layer based on the FGS method.

The multiview encoding unit 114 may encode a multiview video to generate a bitstream, and set multiview scalable extension type information (view ID) representing a video of a view which is encoded for generating the bitstream. For example, when view ID of a left video is 0 and view ID of a right video is 1, the multiview encoding unit 114 sets view ID=0 in a bitstream which is obtained by encoding the left video, and sets view ID=1 in a bitstream which is obtained by encoding the right video. The output unit 120, as described below, adds information representing multiview scalable extension type information (view ID) into a bitstream along with other scalable extension type information.

As described above, different scalable extension types may be combined with each other. Therefore, the video encoding unit 110 may classify an input video sequence into layer videos having different spatio-temporal resolutions, different qualities, and different views, and perform coding for each of classified layers to generate a bitstream having different spatio-temporal resolutions, different qualities, and different views. For example, referring to FIG. 3C, in a case of encoding a video frame constituting video sequences 370 having a temporal resolution of 30 Hz in a left view to generate a bitstream, the video encoding unit 110 may set View ID=0 and Temporal ID=1 as information representing a scalable extension type applied to the video sequences 370. Also, in a case of encoding a video frame constituting video sequences 375 having a temporal resolution of 15 Hz in the left view to generate a bitstream, the video encoding unit 110 may set View ID=0 and Temporal ID=0 as information representing a scalable extension type applied to the video sequences 375. Also, in a case of encoding a video frame constituting video sequences 380 having a temporal resolution of 30 Hz in a right view to generate a bitstream, the video encoding unit 110 may set View ID=1 and Temporal ID=1 as information representing a scalable extension type applied to the video sequences 380. Also, in a case of encoding a video frame constituting video sequences 385 having a temporal resolution of 15 Hz in the right view to generate a bitstream, the video encoding unit 110 may set View ID=1 and Temporal ID=0 as information representing a scalable extension type applied to the video sequences 385.

Referring again to FIG. 1, the output unit 120 adds scalable extension type information, including a video encoded by the video encoding unit 110, into an encoded bitstream, and outputs the bitstream.

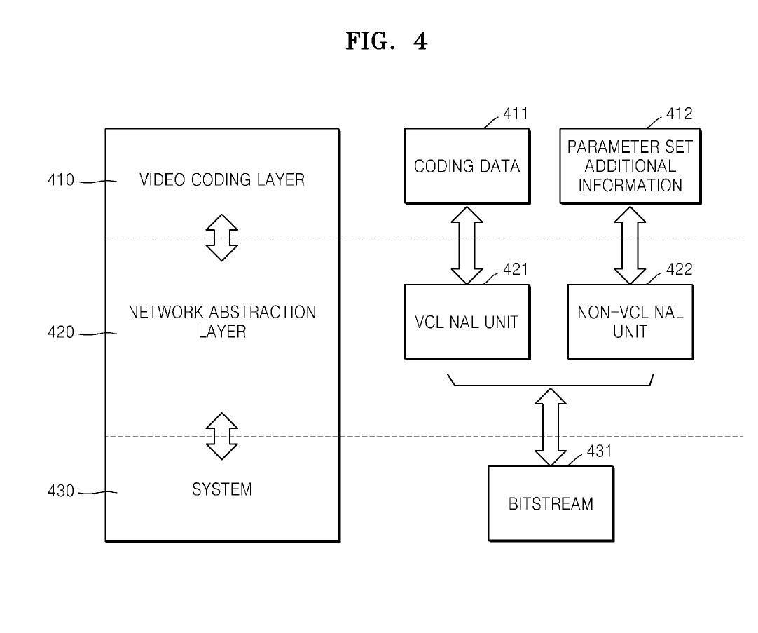

FIG. 4 is a diagram in which a video encoding process and a video decoding process according to an embodiment of the present invention are hierarchically classified.

An encoding process performed by the scalable video encoding apparatus 100 of FIG. 1, as illustrated in FIG. 4, may be divided into an encoding process, which is performed in a video coding layer (VCL) 410 where video coding processing itself is performed, and an encoding process which is performed in a network abstraction layer (NAL) 420 which generates a bitstream based on a certain format by using additional information and video data encoded between the VCL 410 and a lower system 430 which transmits and stores encoded video data. Coding data 411 which is an output of the encoding process performed by the video coding unit 110 of the scalable video encoding apparatus 100 of FIG. 1 is VCL data, and the coding data 411 is mapped in a VCL NAL unit 421 by the output unit 120. Also, pieces of parameter set information 412 associated with an encoding process, such as scalable extension type information and prediction mode information about a coding unit which is used to generate the data 411 encoded in the VCL 410, are mapped in a non-VCL NAL unit 422. In particular, according to an embodiment of the present invention, scalable extension type information is added into a reserved NAL unit for future extension among NAL units, and is transmitted.

FIG. 5 is a diagram illustrating an NAL unit according to an embodiment of the present invention.

An NAL unit 500 is composed of an NAL header and a raw byte sequence payload (RBSP). Referring to FIG. 5, the NAL header includes forbidden_zero_bit (F) 501, nal_ref_flag (NRF) 502 which is a flag representing whether significant additional information is included, and an identifier (nal_unit_type (NUT)) 513 representing a type of the NAL unit 500. The RBSP includes table index information (a scalable extension type, hereinafter referred to as an SET) 514 for scalable extension type information and layer index information (a layer ID, referred to as an LID) 515 which represents a scalable extension type of an encoded video among combinations of a plurality of scalable extension types included in a scalable extension type information table.

The forbidden_zero_bit (F) 501 has a value “0” as a bit for identifying the NAL unit 500. The nal_ref_flag (NRF) 502 may be set to have a value “1” when a corresponding NAL unit includes sequence parameter set (SPS) information, picture parameter set (PPS) information, and information about a reference picture which is used as reference information of another picture, or includes scalable extension type information according to an embodiment of the present invention. The nal_unit_type (NUT) 513 may be classified into an instantaneous decoding refresh (IDR) picture, a clean random access (CRA) picture, an SPS, a picture parameter set (PPS), supplement enhancement information (SEI), an adaptation parameter set (APS), an NAL unit which is reserved to be used for future extension, and an unspecified NAL unit, based on a value of the NUT 513. Table 1 is an example showing a type of the NAL unit 500, based on a value of the identifier (NUT) 513.

TABLE 1

| nal_unit_type | Types of NAL unit |
|---|---|
| 0 | Unspecified |
| 1 | Picture, instead of CRA, and picture slice instead of IDR |
| 2-3 | Reserved for future extension |
| 4 | Slice of CRA picture |
| 5 | Slice of IDR picture |
| 6 | SEI |
| 7 | SPS |
| 8 | PPS |
| 9 | Access unit (AU) delimiter |
| 10-11 | Reserved for future extension |
| 12 | Filler data |
| 13 | Reserved for future extension |
| 14 | APS |
| 15-23 | Reserved for future extension |
| 24-64 | Unspecified |

According to an embodiment of the present invention, information representing a scalable extension type is added into the NAL unit 500 in which a value of the NUT 513 has one of values of 2-3, 10-11, 13, 15-23, and 24-26. That is, according to an embodiment of the present invention, a bitstream which is compatible with another video compression standard and provides scalability may be generated by adding scalable extension type information into an unspecified NAL unit or an NAL unit which is reserved to be used for future extension. The present embodiment is not limited to types of the NAL unit listed in Table 1, and an NAL unit which is unspecified or reserved for future extension in various video compression standards may be used as a data unit for transmitting scalable extension type information.

Referring again to FIG. 5, the output unit 120 may add scalable extension type information into L (where L is an integer) number of bits corresponding to an RBSP region. The output unit 120 classifies the L bits for the scalable extension type information into SET 514 composed of M (where M is an integer) number of bits and LID 515 composed of N (where N is an integer) number of bits.

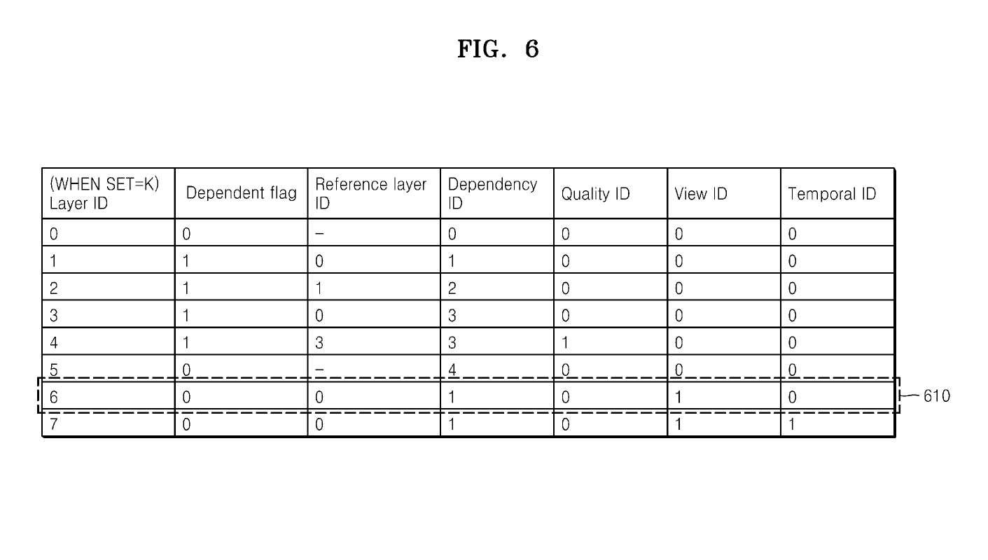

FIG. 6 is a diagram illustrating a scalable extension type information table according to an embodiment of the present invention.

When the SET 514 has a specific value, one scalable extension type information table is specified. Referring to FIG. 6, one scalable extension type information table shows one of combinations of scalable extension types, based on a value of the LID 515. When the SET 514 has a value “k (where k is an integer)”, as shown, one scalable extension type information table is specified, and which combination of combinations of scalable extension types is represented may be determined based on the value of the LID 515. For example, when it is assumed that the SET 514 has k and the LID 515 has a value “6”, a corresponding NAL unit represents scalable extension type information corresponding to Dependent flag=0, Reference layer ID=0, Dependency ID=1, Quality ID=0, View ID=1, and Temporal ID=0 which are combinations of scalable extension types referred to by reference numeral 610.

In FIG. 6, a scalable extension type information table when the SET 514 has a specific value “k” is shown. However, as shown in FIG. 5, when the SET 514 is composed of the M bits, the SET 514 may have a maximum of 2̂M values, and thus, a maximum of 2̂M scalable extension type information tables may be previously specified based on a value of the SET 514. The scalable extension type information table shown in FIG. 6 may be previously specified in a video encoding apparatus and a video decoding apparatus, or may be transferred from the video encoding apparatus to the video decoding apparatus by using SPS, PPS, and SEI messages.

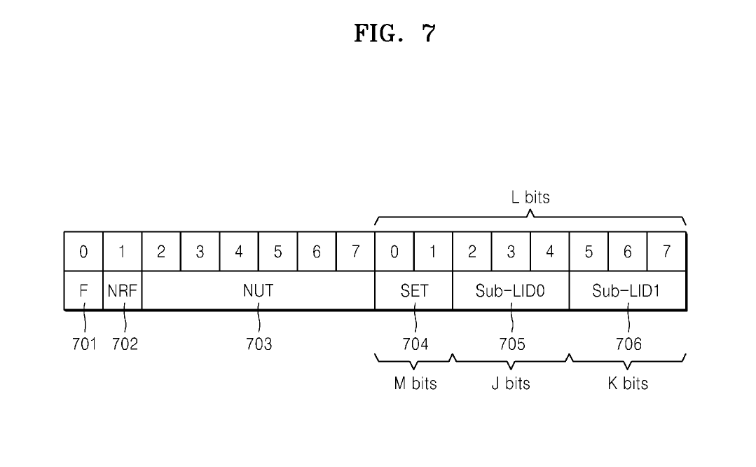

FIG. 7 is a diagram illustrating an NAL unit according to another embodiment of the present invention.

In an NAL unit 500, forbidden_zero_bit (F) 701 corresponding to an NAL header, nal_ref_flag (NRF) 702, and an identifier (NUT) 703 representing a type of the NAL unit 700 are the same as those of FIG. 5, and thus, their detailed descriptions are not provided. Similarly to the NAL unit 500 of FIG. 5, scalable extension type information may be included in an RBSP region of a specified NAL unit or an NAL unit which is reserved to be used for future extension.

The output unit 120 may add scalable extension type information into L (where L is an integer) number of bits corresponding to an RBSP region of the NAL unit 700. The output unit 120 classifies the L bits for the scalable extension type information into SET 704 composed of M number of bits, a first sub-layer index (Sub-LID0) 705 composed of J (where J is an integer) number of bits, and a second sub-layer index (Sub-LID1) 706 composed of K (where K is an integer) number of bits.

Unlike the SET 504 of FIG. 5, the SET 704 of FIG. 7 is combination scalable index information representing what scalable extension type information the first sub-layer index (Sub-LID0) 705 and the second sub-layer index (Sub-LID1) 706 are, and is information for determining which of pieces of scalable extension type information each of the first sub-layer index (Sub-LID0) 705 and the second sub-layer index (Sub-LID1) 706 corresponds to.

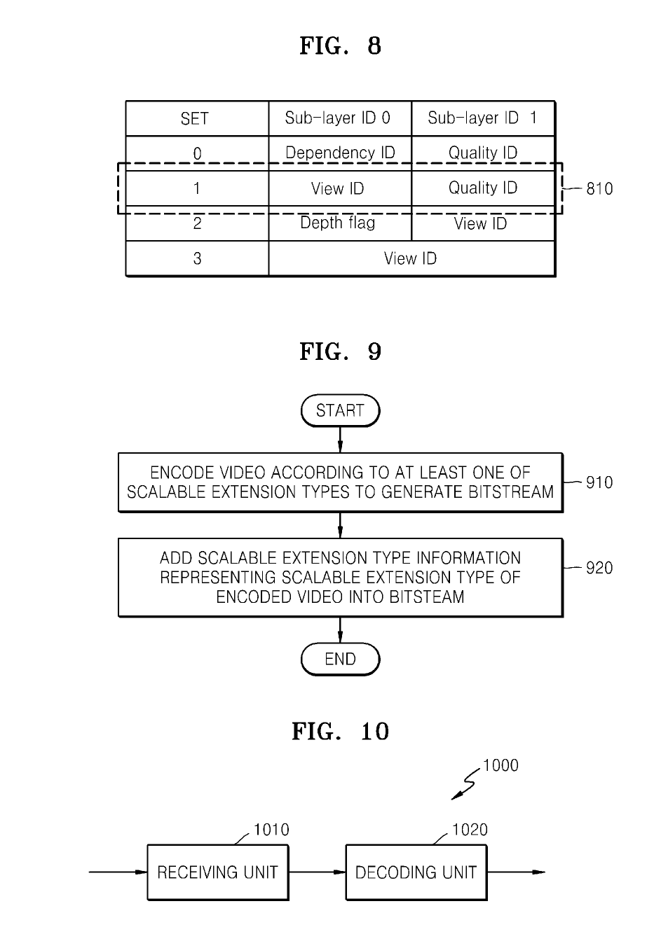

FIG. 8 is a diagram illustrating scalable extension type information which the first sub-layer index (Sub-LID0) 705 and the second sub-layer index (Sub-LID1) 706 indicate, based on the SET 704 of the NAL unit of FIG. 7.

Referring to FIG. 8, what scalable extension type information the first sub-layer index (Sub-LID0) 705 and the second sub-layer index (Sub-LID1) 706 represents may be represented based on a value of the SET 704. For example, when the SET 704 has a value “1”, as referred to by reference numeral 810, a value of the first sub-layer index (Sub-LID0) 705 subsequent to the SET 714 represents temporal scalable extension type information (View ID), and a value of the second sub-layer index (Sub-LID1) 706 represents quality scalable extension type information (View ID).

In FIG. 7, a total of two sub-layer indexes including the first sub-layer index (Sub-LID0) 705 and the second sub-layer index (Sub-LID1) 706 are shown, but the present embodiment is not limited thereto. For example, a sub-layer index may be extended to represent two or more pieces of scalable extension type information within a range of the number of available bits.

FIG. 9 is a flowchart illustrating a scalable video encoding method according to an embodiment of the present invention.

Referring to FIG. 9, in operation 910, the video encoding unit 110 encodes a video according to at least one of a plurality of scalable extension types to generate a bitstream. As described above, the video encoding unit 110 may classify an input video sequence into layer videos having different spatio-temporal resolutions, different qualities, and different views, and perform coding for each of classified layers to generate a bitstream having different spatio-temporal resolutions, different qualities, and different views.

In operation 920, the output unit 120 adds scalable extension type information representing a scalable extension type of an encoded video into a bitsteam. As described above, the scalable extension type information may be added into an RBSP region of an unused NAL unit or an NAL unit which is reserved to be used for future extension among NAL units, and may be transmitted.

In detail, as in FIG. 5, the output unit 120 may add, into RBSP of an NAL unit, the table index information (SET) 514 representing one of a plurality of scalable extension type information tables in which available combinations of a plurality of scalable extension types are specified and the layer index information (LID) 515 representing a scalable extension type of an encoded video among combinations of a plurality of scalable extension types included in a scalable extension type information table.

Moreover, according to another embodiment, as in FIG. 7, the output unit 120 adds the combination scalable index information (SET) 704 and pieces of the sub-layer index information (Sub-LID0 and Sub-LID1) 705 and 706, and a value of the combination scalable index information (SET) 704 is set to represent which of a plurality of scalable extension layers the pieces of sub-layer index information are mapped to. Each of the pieces of sub-layer index information (Sub-LID0 and Sub-LID1) 705 and 706 may be set to represent a specific scalable extension type of an encoded video.

FIG. 10 is a block diagram of a scalable video decoding apparatus 1000 according to an embodiment of the present invention. Referring to FIG. 10, the scalable video decoding apparatus 1000 according to an embodiment of the present invention includes a receiving unit 1010 and a decoding unit 1020.

The receiving unit 1010 receives an NAL unit of a network abstraction layer, and obtains an NAL unit including scalable extension type information. The NAL unit including the scalable extension type information may be determined by using nal_unit_type (NUT) which is an identifier representing a type of the NAL unit. As described above, the scalable extension type information according to embodiments of the present invention may be included in an unused NAL unit or an NAL unit which is reserved to be used for future extension.

The receiving unit 1010 parses an NAL unit including scalable extension type information to determine which scalability a currently decoded video has. For example, as illustrated in FIG. 5, when the NAL unit including the scalable extension type information includes the table index information (SET) 514 representing one of a plurality of scalable extension type information tables in which available combinations of a plurality of scalable extension types are specified and the layer index information (LID) 515 representing a scalable extension type of an encoded video among combinations of a plurality of scalable extension types included in a scalable extension type information table, the receiving unit 1010 determines one of the plurality of scalable extension type tables, based on a value of the table index information (SET) 514, and determines one combination of scalable extension types of the scalable extension type table which is determined by using the layer index information (LID) 515.

For example, as shown in FIG. 7, when the NAL unit including the scalable extension type information includes the combination scalable index information (SET) 704 and the pieces of sub-layer index information (Sub-LID0 and Sub-LID1) 705 and 706, the receiving unit 1010 determines which of a plurality of scalable extension types the pieces of sub-layer index information (Sub-LID0 and Sub-LID1) 705 and 706 are mapped to, based on a value of the combination scalable index information (SET) 704, and determines a mapped scalable extension type, based on a value of each of the pieces of sub-layer index information (Sub-LID0 and Sub-LID1) 705 and 706.

The decoding unit 1020 decodes an encoded video according to an obtained scalable extension type to output a scalable restoration video. That is, the decoding unit 1020 decodes a bitstream to restore and output layer videos having different spatio-temporal resolutions, different qualities, and different views.

FIG. 11 is a flowchart illustrating a scalable video decoding method according to an embodiment of the present invention.

Referring to FIG. 11, in operation 1110, the receiving unit 1010 receives and parses a bitstream of an encoded video to obtain a scalable extension type of the encoded video among a plurality of scalable extension types. As described, the receiving unit 1010 obtains an NAL unit including scalable extension type information, and the receiving unit 1010 parses an NAL unit including scalable extension type information to determine which scalability a currently decoded video has. For example, when the NAL unit is the NAL unit including the scalable extension type information shown in FIG. 5, the receiving unit 1010 determines one of the plurality of scalable extension type tables, based on a value of the table index information (SET) 514, and determines one combination of scalable extension types of the scalable extension type table which is determined by using the layer index information (LID) 515. For example, when the receiving unit 1010 receives the NAL unit including the scalable extension type information shown in FIG. 7, the receiving unit 1010 determines which of a plurality of scalable extension types the pieces of sub-layer index information (Sub-LID0 and Sub-LID1) 705 and 706 are mapped to, based on a value of the combination scalable index information (SET) 704, and determines a mapped scalable extension type, based on a value of each of the pieces of sub-layer index information (Sub-LID0 and Sub-LID1) 705 and 706.

In operation 1120, the decoding unit 1020 decodes an encoded video according to an obtained scalable extension type to output a scalable restoration video. That is, the decoding unit 1020 decodes a bitstream to restore and output layer videos having different spatio-temporal resolutions, different qualities, and different views.

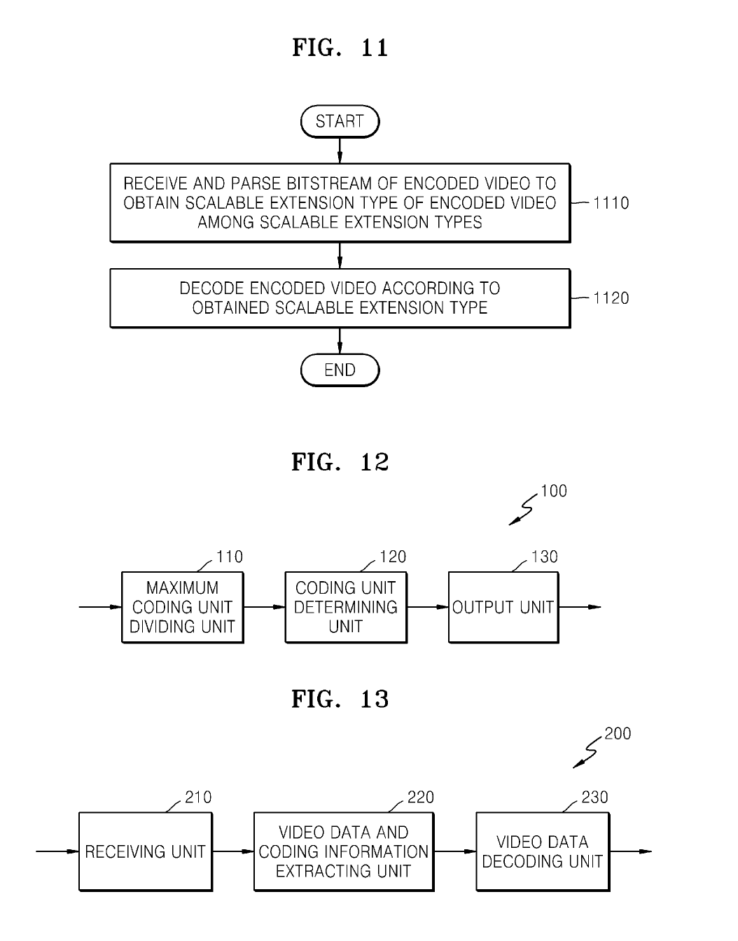

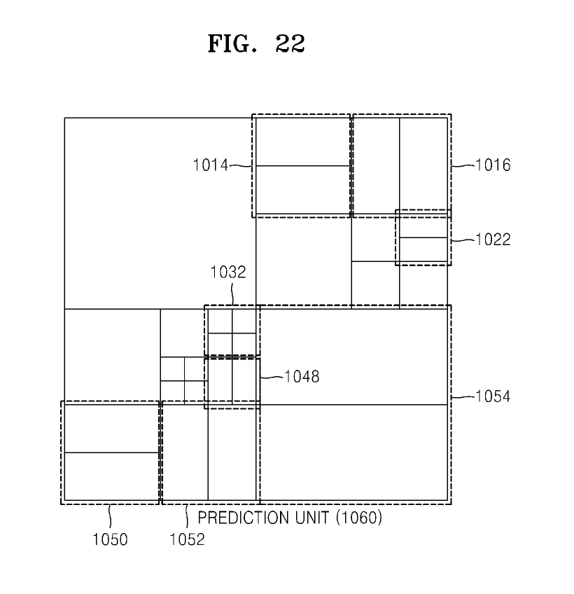

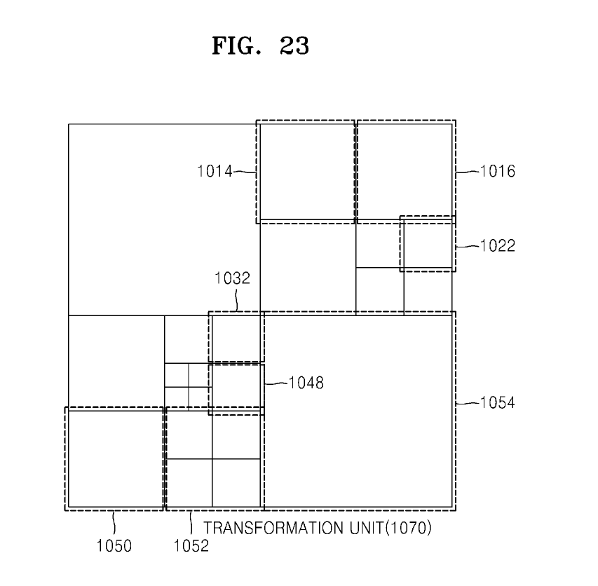

The scalable video encoding apparatus 100 and the scalable video decoding apparatus 1000 according to an embodiment of the present invention may respectively perform coding and decoding on the basis of a coding unit based on a tree structure instead of a related art macro block. Hereinafter, a video encoding method and apparatus which perform predictive encoding on a prediction unit and a partition on the basis of coding units based on a tree structure and a video decoding method and apparatus which perform predictive decoding will be described in detail with reference to FIGS. 12 to 24.

FIG. 12 illustrates a block diagram of a video encoding apparatus which performs video prediction on the basis of a coding unit based on a tree structure, according to an embodiment of the present invention. The video encoding apparatus 100, which performs video prediction on the basis of a coding unit based on a tree structure according to an embodiment, includes a maximum coding unit dividing unit 110, a coding unit determining unit 120, and an output unit 130. Hereinafter, for convenience of description, the video encoding apparatus 100 which performs video prediction on the basis of a coding unit based on a tree structure according to an embodiment is simply referred to as a video encoding apparatus 100.

The maximum coding unit dividing unit 110 may divide a current picture, based on a maximum coding unit that is a coding unit of a maximum size for the current picture of a video. When the current picture is greater than the maximum coding unit, video data of the current picture may be divided into at least one maximum coding unit. The maximum coding unit is a data unit having a size of 32×32, 64×64, 128×128, or 256×256, and may be a square data unit in which a width and height size is a power of 2. Video data may be output to the coding unit determining unit 120 by at least one maximum unit.

A coding unit according to an embodiment may be characterized as a maximum size and a depth. The depth denotes the number of times in which a coding unit is spatially divided from a maximum coding unit. As the depth becomes deeper, a coding unit according to depths may be divided from the maximum coding unit to a minimum coding unit. A depth of the maximum coding unit is an uppermost depth, and the minimum coding unit may be defined as a lowermost coding unit. In the maximum coding unit, as the depth becomes deeper, a size of the coding unit of depth decreases, and thus, a coding unit of an upper depth may include a plurality of coding units of a lower depth.

As described above, video data of a current picture is divided into maximum coding units according to a maximum size of a coding unit, and each of the maximum coding units may include a plurality of coding units divided according to depth. A maximum coding unit according to an embodiment is divided according to depth, and thus, video data of a spatial domain included in the maximum coding unit may be hierarchically classified according to a depth.

A maximum depth and a maximum size of a coding unit, which limit the total number of times in which a height and a width of a maximum coding unit is hierarchically divided, may be previously set.

The coding unit determining unit 120 encodes at least one split region obtained by splitting a region of the maximum coding unit according to depths, and determines a depth to output final encoding results according to the at least one split region. In other words, the coding unit determiner 120 determines a coded depth by encoding the image data in the deeper coding units according to depths, according to the maximum coding unit of the current picture, and selecting a depth having a smallest encoding error. The determined coding depth and video data according to the maximum coding unit are output to the output unit 130.

Video data in a maximum coding unit is encoded based on a depth-based coding unit according to at least one depth equal to or less than a maximum depth, and an encoding result based on each depth-based coding unit is compared. A depth in which an encoding error is smallest may be selected as a comparison result of an encoding error of a depth-based coding unit. At least one coding depth may be determined for each maximum coding unit.

In a size of a maximum coding unit, as a depth becomes deeper, a coding unit is hierarchically split, and the number of coding units increases. Also, even in a case of coding units of the same depth included in one maximum coding unit, an encoding error of each data is measured, and whether to split a coding unit into coding units of a lower depth is determined. Therefore, even in a case of data included in one maximum coding unit, a depth-based encoding error is changed depending on a position, and thus, a coding depth may be differently determined depending on a position. Thus, one or more coding depths may be set for one maximum coding unit, and data of a maximum coding unit may be divided according to coding units of one or more coding depths.

Therefore, the coding unit determining unit 120 according to an embodiment may determine a plurality of coding units which is based on a tree structure and are included in a current maximum coding unit. The coding units based on the tree structure according to an embodiment include coding units of a depth, which is determined as a coding depth, among all depth-based coding units included in the current maximum coding unit. A coding unit of a coding depth is hierarchically determined according to a depth in the same domain in a maximum coding unit, and may be independently determined in other domains. Similarly, a coding depth of a current domain may be determined independently from a coding depth of another domain.

A maximum depth according to an embodiment is an indicator relating to the number of divisions from a maximum coding unit to a minimum coding unit. A first maximum depth according to an embodiment may represent the total number of divisions from the maximum coding unit to the minimum coding unit. A second maximum depth according to an embodiment may represent the total number of depth levels from the maximum coding unit to the minimum coding unit. For example, when a depth of the maximum coding unit is 0, a depth of a coding unit in which the maximum coding unit is divided once may be set to 1, and a depth of a coding unit in which the maximum coding unit is divided twice may be set to 2. In this case, when a coding unit which is divided from the maximum coding unit four times is the minimum coding unit, there are depth levels of 0, 1, 2, 3, and 4, and thus, the first maximum depth may be set to 4, and the second maximum depth may be set to 5.

Prediction encoding and frequency transformation may be performed according to the maximum coding unit. The prediction encoding and the frequency transformation are also performed based on the deeper coding units according to a depth equal to or depths less than the maximum depth, according to the maximum coding unit.

Because a number of deeper coding units increases whenever the maximum coding unit is split according to depths, encoding including the prediction encoding and the frequency transformation is performed on all of the deeper coding units generated as the depth increases. Hereinafter, for convenience of description, predictive encoding and transformation will be described based on a coding unit of a current depth among at least one or more maximum coding units.

The video encoding apparatus 100 according to an embodiment may variously select a size or form of a data unit for encoding video data. Operations such as predictive encoding, transformation, and entropy encoding are performed for encoding a video data. In this case, the same data unit may be applied to all the operations, or a data unit may be changed in each of the operations.

For example, in order to perform predictive encoding of video data of a coding unit, the video encoding apparatus 100 may select a data unit which differs from a coding unit, in addition to a coding unit for encoding video data.

In order to perform predictive encoding of a maximum coding unit, predictive encoding may be performed based on a coding unit of a coding depth according to an embodiment, namely, a coding unit which is no longer split. Hereinafter, a coding unit which is based on predictive encoding and is no longer split is referred to as a prediction unit. A partition into which the prediction unit is split may include a data unit into which at least one selected from the prediction unit and a height and a width of the prediction unit is split. The partition is a data unit having a type in which a prediction unit of a coding unit is split, and the prediction unit may be a partition of the same size as that of a coding unit.

For example, when a coding unit of a size “2N×2N (where N is a positive integer)” is no longer split, the coding unit becomes a prediction unit of a size “2N×2N”, and a size of a partition may be 2N×2N, 2N×N, N×2N, or N×N. A partition type according to an embodiment may selectively include partitions which are split at an asymmetric ratio such as 1:n or n:1, partitions which are split in a geometric form, and partitions having an arbitrary form, in addition to symmetric partitions into which a height or a width of a prediction unit is split at a symmetric ratio.

A prediction mode of a prediction unit may be at least one selected from an intra mode, an inter mode, and a skip mode. For example, the intra mode and the inter mode may be performed for a partition having a size of 2N×2N, 2N×N, N×2N, or N×N. Also, the skip mode may be performed for only a partition of a size “2N×2N”. Encoding is independently performed per one prediction unit by a coding unit, and thus, a prediction mode in which an encoding error is smallest may be selected.

Moreover, the video encoding apparatus 100 according to an embodiment may perform transformation of video data of a coding unit, based on a data unit which differs from the coding unit, in addition to the coding unit for encoding the video data. In order to perform transformation of a coding unit, the transformation may be performed based on a transformation unit of a size which is equal to or less than that of the coding unit. For example, the transformation unit may include a data unit for the intra mode and a transformation unit for the inter mode. A transformation unit included in a coding unit may be recursively divided into transformation units of a smaller size by a method similar to a coding unit based on a tree structure according to an embodiment, and residual data of an coding unit may be divided according to a transformation unit based on a tree structure depending on a transformation depth.

In a transformation unit according to an embodiment, a height and a width of a coding unit may be divided, and thus, a transformation depth representing the number of divisions up to a transformation unit may be set. For example, when a size of a transformation unit of a current coding unit having a size “2N×2N” is 2N×2N, a transformation depth may be set to 0, and when the size of the transformation unit is N×N, the transformation depth may be set to 1. Also, when the size of the transformation unit is N/2×N/2, the transformation depth may be set to 2. That is, a transformation unit based on a tree structure may be set based on a transformation depth.

Coding depth-based encoding information needs prediction-related information and transformation-related information, in addition to a coding depth. Therefore, the coding unit determining unit 120 may determine a partition type in which a prediction unit is divided into partitions, a prediction unit-based prediction mode, and a size of a transformation unit for transformation, in addition to a coding depth which causes a minimum encoding error.

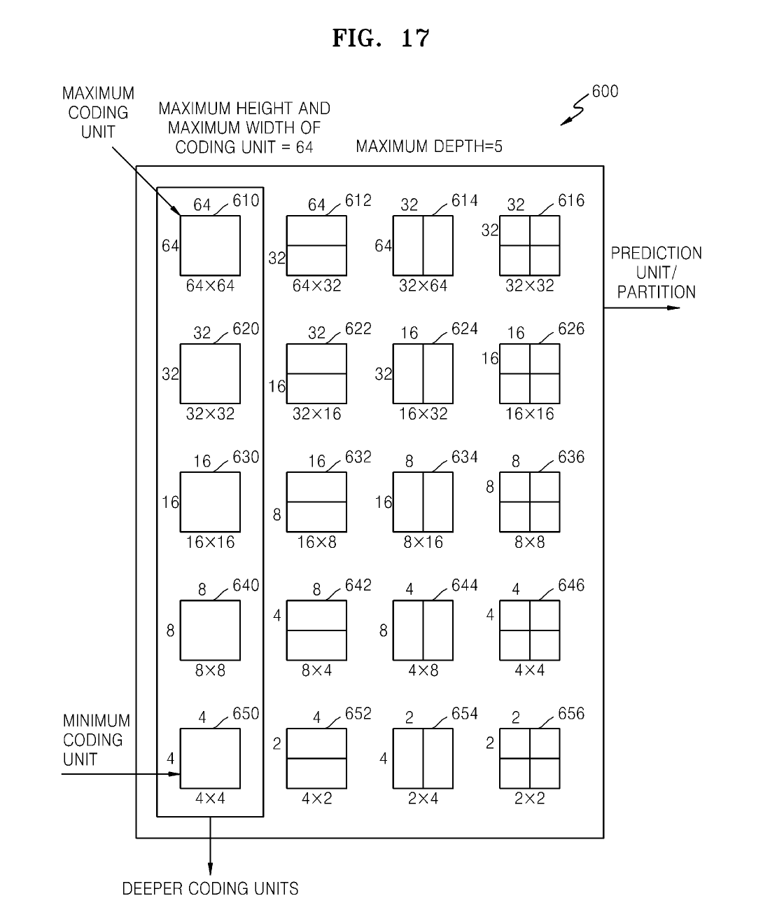

A coding unit and a prediction unit/partition based on a tree structure of a maximum coding unit according to an embodiment and a method of determining a transformation unit will be described in detail with reference to FIGS. 17 to 24.

The coding unit determining unit 120 may measure an encoding error of a depth-based coding unit by using a rate-distortion optimization technique based on a Lagrangian multiplier.

The output unit 130 outputs, in a bitstream form, a depth-based encoding mode and video data of a maximum coding unit encoded based on at least one coding depth determined by the coding unit determining unit 120.

The encoded video data may be an encoding result of residual data of a video.

Information about a depth-based encoding mode may include coding depth information, partition type information of a prediction unit, prediction mode information, and size information of a transformation unit.

The coding depth information may be defined by using depth-based split information which represents whether to perform coding by a coding unit of a lower depth without performing coding at a current depth. When a current depth of a current coding unit is a coding depth, the current coding unit is encoded by a coding unit of a current depth, and thus, split information of a current depth may be defined so that a depth is no longer split into lower depths. On the other hand, when the current depth of the current coding unit is not the coding depth, it is required to attempt coding based on a coding unit of a lower depth, and thus, the split information of the current depth may be defined so as not to be split into coding units of a lower depth.

When a current depth is not a coding depth, coding is performed for a coding unit which is divided into coding units of a lower depth. One or more coding units of a lower depth exist included in a coding unit of a current depth, and thus, coding is repeatedly performed per coding unit of each lower depth, whereby recursive coding may be performed per coding unit of the same depth.

Coding units having a tree structure are determined in one maximum coding unit, and information about at least one encoding mode should be determined per coding unit of a coding depth, whereby information about at least one encoding mode may be determined for one maximum coding unit. Also, data of a maximum coding unit is hierarchically split based on a depth, and coding depths by position differ, whereby a coding depth and information about an encoding mode may be set for data.

Therefore, the output unit 130 according to an embodiment may allocate encoding information about a corresponding coding depth and encoding mode, for at least one selected from a coding unit, a prediction unit, and a minimum unit which are included in a maximum coding unit.

A minimum unit according to an embodiment is a square data unit having a size of when a minimum coding unit that is a lowermost coding depth is split by four. A minimum unit according to an embodiment may be a square data unit of a maximum size which may be included all coding units, a prediction unit, a partition unit, and a transformation unit which are included in a maximum coding unit.

For example, encoding information output through the output unit 130 may be classified into depth-based coding unit-based encoding information and prediction unit-based encoding information. The depth-based coding unit-based encoding information may include prediction mode information and partition size information. Encoding information transmitted by prediction unit may include information about an estimation direction of the inter mode, information about a reference video index of the inter mode, information about a motion vector, information about a chroma component of the intra mode, and information about an interpolation method of the intra mode.

Information about a maximum size and information about a maximum depth of a coding unit, which is defined by picture, slice, or GOP, may be inserted into a header of a bitstream, a sequence parameter set, or a picture parameter set.

Moreover, information about a maximum size of a transformation unit which is allowed for a current video and information about a minimum size of the transformation unit may be output through the header of the bitstream, the sequence parameter set, or the picture parameter set.

The output unit 130 may encode and output information about scalability of a coding unit described above with reference to FIGS. 5 to 8.

According to an embodiment of the simplest form of the video encoding apparatus 100, a depth-based coding unit is a coding unit having a size of when a height and a width of a coding unit of one layer upper depth are split by two. That is, when a size of a coding unit of a current depth is 2N×2N, a size of a coding unit of a lower depth is N×N. Also, a current coding unit of a size “2N×2N” may include a maximum of four lower depth coding units having a size “N×N”.

Therefore, the video encoding apparatus 100 may determine a coding unit having an optimal type and size per maximum coding unit to construct a plurality of coding units based on a tree structure, based on a maximum depth and a size of a maximum coding unit which is determined in consideration of a characteristic of a current picture. Also, coding may be performed in various prediction modes and a transformation method per maximum coding unit, and thus, an optimal encoding mode may be determined in consideration of a video characteristic of a coding unit having various video sizes.

Therefore, when a video in which a resolution is very high or an amount of data is very large is encoded in the existing macro block unit, the number of macro blocks excessively increases per picture. Thus, since compression information generated per macro block increases, a transmission burden of the compression information increases, and data compression efficiency is reduced. Accordingly, the video encoding apparatus according to an embodiment may adjust a coding unit in consideration of a characteristic of a video while increasing a maximum size of a coding unit in consideration of a size of a video, and thus, video compression efficiency can increase.

FIG. 13 illustrates a block diagram of a video decoding apparatus 200 which performs video prediction based on a coding unit based on a tree structure, according to an embodiment of the present invention.

The video decoding apparatus 200, which performs video prediction based on a coding unit based on a tree structure, according to an embodiment of the present invention includes a receiving unit 210, a video data and coding information extracting unit 220, and a video data decoding unit 230. Hereinafter, for convenience of description, the video decoding apparatus 200 which performs video prediction based on a coding unit based on a tree structure according to an embodiment is simply referred to as a video decoding apparatus 200.

Definition of various terms such as a coding unit, a depth, a prediction unit, a transformation unit, and information about various encoding modes for a decoding operation of the video decoding apparatus 200 according to an embodiment is as described above with reference to FIG. 12 and the video encoding apparatus 100. The receiving unit 210 receives and parses a bitstream for an encoded video.

The video data and coding information extracting unit 220 extracts video data, which is encoded per a coding unit according to coding units based on a tree structure by maximum coding unit, from the parsed bitstream, and outputs the extracted video data to the video data decoding unit 230. The video data and coding information extracting unit 220 may extract information about a maximum size of a coding unit of a current picture from a header for the current picture, a sequence parameter set, or a picture parameter set.

Moreover, the video data and coding information extracting unit 220 extracts, from the parsed bitstream, information about an encoding mode and a coding depth for coding units based on the tree structure included in maximum coding unit. The extracted information about the encoding mode and the coding depth is output to the video data decoding unit 230. That is, by dividing video data of a bitstream in a maximum coding unit, the video data decoding unit 230 may decode the video data per maximum coding unit.

The information about the encoding mode and the coding depth by maximum coding unit may be set for one or more coding depth information. Information about the encoding mode by coding depth may include partition type information of a corresponding coding unit, prediction mode information, and size information of a transformation unit. Also, split information by depth may be extracted as coding depth information.

The information about the encoding mode and the coding depth by maximum coding unit, which is extracted by the video data and coding information extracting unit 220, is information about a coding depth and an encoding mode, which is determined by repeatedly performing coding per depth-based coding unit by maximum coding unit to cause a minimum encoding error in an encoding end as in the video encoding apparatus 100 according to an embodiment. Therefore, the video decoding apparatus 200 may decode data according to an encoding method, which causes the minimum encoding error, to restore a video.

Coding information about a coding depth and a decoding mode according to an embodiment may be allocated for a certain data unit among a corresponding coding unit, a prediction unit, and a minimum unit, and thus, the video data and coding information extracting unit 220 may extract information about a coding depth and an encoding mode by certain data unit. When information about an encoding mode and a coding depth of a corresponding maximum coding unit is stored by certain data unit, certain data units having information about the same coding depth and encoding mode may be analogized as a data unit included in the same maximum coding unit.

The video data decoding unit 230 decodes video data of each maximum coding unit to restore a current picture, based on information about a coding depth and an encoding mode by maximum coding unit. That is, the video data decoding unit 230 may decode encoded video data based on a readout partition type, a prediction mode, and a transformation unit per coding unit among coding units which are based on a tree structure and are included in a maximum coding unit. A decoding operation may include a prediction operation, including intra prediction and motion compensation, and an inverse transformation operation.

The video data decoding unit 230 may perform intra prediction or motion compensation according to each partition and prediction mode per coding unit, based on prediction mode information and partition type information of a prediction unit of a coding depth-based coding unit.

Moreover, the video data decoding unit 230 may read out transformation unit information based on a tree structure by coding unit, for inverse transformation by maximum coding unit, and perform inverse transformation based on a transformation unit per coding unit. A pixel value of a spatial domain of a coding unit may be restored through inverse transformation.

The video data decoding unit 230 may determine a coding depth of a current maximum coding unit by using split information according to depth. For example, when the split information represents that split is no longer performed in a current depth, the current depth is a coding depth. Therefore, the video data decoding unit 230 may decode a coding unit of the current depth for video data of a current maximum coding unit by using a partition type of a prediction unit, a prediction mode, and transformation unit size information.

That is, coding information which is set for a certain data unit among a coding unit, a prediction unit, and a minimum unit is observed, and a data unit which retains encoding information including the same split information may be collected and may be regarded as one data unit which is to be decoded by the video data decoding unit 230 in the same decoding mode. Information about an encoding mode may be obtained per coding unit determined by the above-described method, and decoding of a current coding unit may be performed.

The video decoding apparatus 200 may recursively perform coding per maximum coding unit in an encoding operation to obtain information a coding unit which causes a minimum encoding error, and may use the obtained information for decoding of a current picture. That is, it is possible to decode encoded video data of coding units which are based on a tree structure and are determined in an optimal coding unit per maximum coding unit.

Therefore, even in a case of a video in which a resolution is high or a video in which an amount of data is excessively large, by using information about an optimal encoding mode transmitted from an encoding end, the video may be restored by efficiently decoding video data according to a size of a coding unit and an encoding mode which are adaptively determined based on a characteristic of the video.

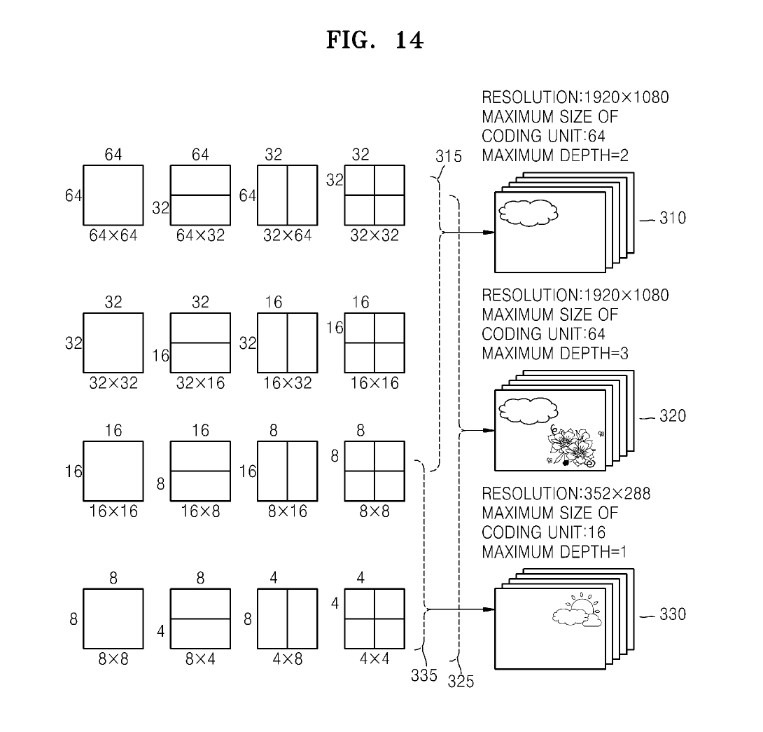

FIG. 14 illustrates a concept of a coding unit according to an embodiment of the present invention.

As an example of a coding unit, a size of the coding unit is expressed as width×height, and may include 32×32, 16×16, and 8×8 from a coding unit of a size “64×64”. The coding unit of a size “64×64” may be divided into partitions having sizes of 64×64, 64×32, 32×64, and 32×32. A coding unit of a size “32×32” may be divided into partitions having sizes of 32×32, 32×16, 16×32, and 16×16. A coding unit of a size “16×16” may be divided into partitions having sizes of 16×16, 16×8, 8×16, and 8×8. A coding unit of a size “8×8” may be divided into partitions having sizes of 8×8, 8×4, 4×8, and 4×4.

In video data 310, a resolution is set to 1920×1080, a maximum size of a coding unit is set to 64, and a maximum depth is set to 2. In video data 320, a resolution is set to 1920×1080, a maximum size of a coding unit is set to 64, and a maximum depth is set to 3. In video data 330, a resolution is set to 352×288, a maximum size of a coding unit is set to 16, and a maximum depth is set to 1. A maximum depth illustrated in FIG. 9 represents the total number of divisions from a maximum coding unit to a minimum coding unit.

In a case where a resolution is high or an amount of data is large, encoding efficiency is enhanced, and moreover, a maximum size of an encoding size may be relatively large for accurately reflecting a characteristic of a video. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 because depths are increased to two layers by splitting the maximum coding unit twice. Meanwhile, because the maximum depth of the video data 330 is 1, coding units 335 of the video data 330 may include a maximum coding unit having a long axis size of 16, and coding units having a long axis size of 8 because depths are increased to one layer by splitting the maximum coding unit once.

Because the maximum depth of the video data 320 is 3, coding units 325 of the video data 320 may include a maximum coding unit having a long axis size of 64, and coding units having long axis sizes of 32, 16, and 8 because the depths are increased to 3 layers by splitting the maximum coding unit three times. As a depth increases, detailed information may be more precisely expressed.

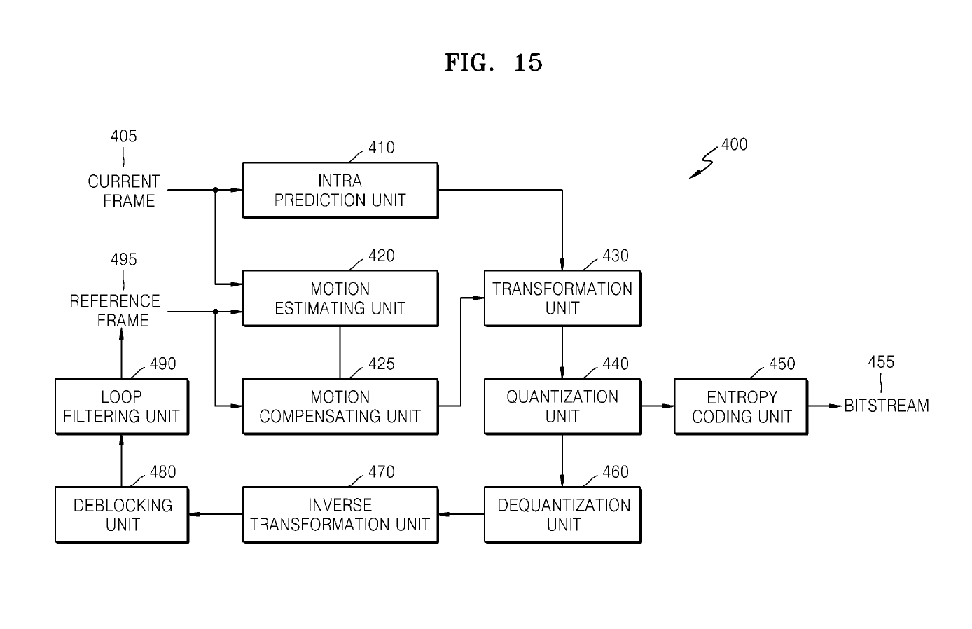

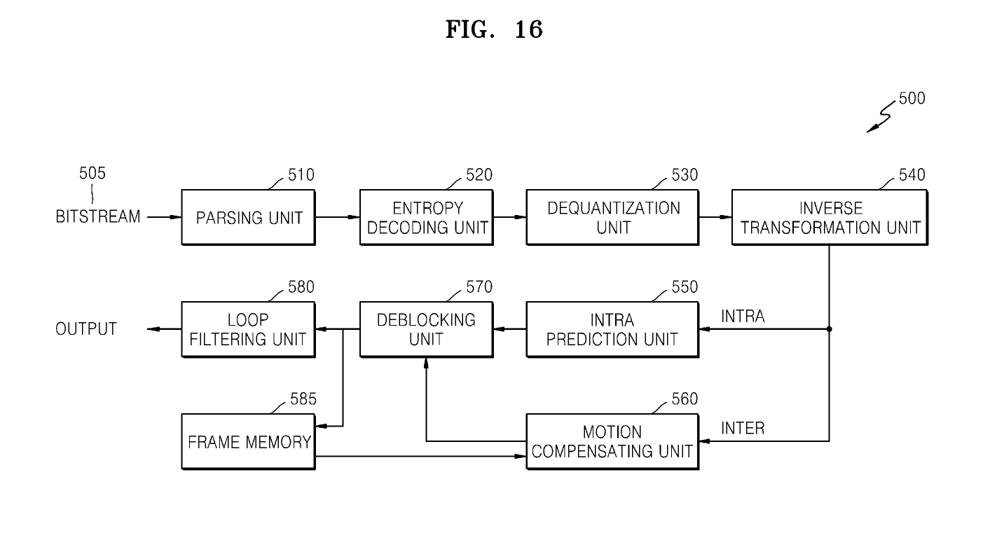

FIG. 15 illustrates a block diagram of a video coding unit 400 based on a coding unit according to an embodiment of the present invention.

The video coding unit 400 according to an embodiment includes operations which are performed in encoding video data in the coding unit determining unit 120 of the video encoding apparatus 100. That is, an intra prediction unit 410 performs intra prediction on a coding unit of an intra mode in a current frame 405, and a motion estimating unit 420 performs inter estimation by using the current frame 405 and a reference frame 495 of an inter mode. A motion compensating unit 425 performs motion compensation by using the current frame 405 and reference frame 495 of the inter mode.

Data output from the intra prediction unit 410, the motion estimating unit 420, and the motion compensating unit 425 is output as a quantized transformation coefficient via a transformation unit 430 and a quantization unit 440. The quantized transformation coefficient is restored to data of a spatial domain by a dequantization unit 460 and an inverse transformation unit 470, and the restored data of the spatial domain is post-processed by a deblocking unit 480 and a loop filtering unit 490, and is output as the reference frame 495. The quantized transformation coefficient may be output as a bitstream 455 via an entropy coding unit 450.

In order to apply the video encoding unit 400 to the video encoding apparatus 100 according to an embodiment, the intra prediction unit 410, the motion estimating unit 420, the motion compensating unit 425, the transformation unit 430, the quantization unit 440, the entropy encoding unit 450, the dequantization unit 460, the inverse transformation unit 470, the deblocking unit 480, and the loop filtering unit 490 which are elements of the video encoding unit 400 should all perform an operation based on each coding unit among a plurality of coding units based on a tree structure in consideration of a maximum depth for each maximum coding unit.

In particular, the intra prediction unit 410, the motion estimating unit 420, and the motion compensating unit 425 determine a partition and a prediction mode of each coding unit among the plurality of coding units based on the tree structure in consideration of a maximum size and a maximum depth of a current maximum coding unit, and the transformation unit 430 determines a size of a transformation unit in each coding unit among the plurality of coding units based on the tree structure.

FIG. 16 illustrates a block diagram of a video decoding unit based on a coding unit according to an embodiment of the present invention.

A bitstream 505 is input to a parsing unit 510, and encoded video data that is a decoding target and information about encoding which is necessary for decoding are parsed. The encoded image data is output as inverse quantized data through an entropy decoding unit 520 and a dequantization unit 530, and the inverse quantized data is restored to image data in a spatial domain through an inverse transformation unit 540.

In the video data of the spatial domain, an intra prediction unit 550 performs intra prediction on a coding unit of an intra mode, and a motion compensating unit 560 performs motion compensation on a coding unit of an inter mode by using a reference frame 585.

Data of the spatial domain is post-processed by a deblocking unit 570 and a loop filtering unit 580, and is output as a restoration frame 595. Also, the data post-processed by the deblocking unit 570 and the loop filtering unit 580 may be output as the reference frame 585.

Operations subsequent to the parsing unit 510 of the video decoding unit 500 according to an embodiment may be performed for decoding video data in the video data encoding unit 230 of the video decoding apparatus 200.

In order to apply the video decoding unit to the video decoding apparatus 200 according to an embodiment, the parsing unit 510, the entropy decoding unit 520, the dequantization unit 530, the inverse transformation unit 540, the intra prediction unit 550, the motion compensating unit 560, the deblocking unit 570, and the loop filtering unit 580 which are elements of the video encoding unit 400 perform operations based on coding units having a tree structure for each maximum coding unit.

In particular, the intra prediction unit 550 and the motion compensating unit 560, determine partitions and a prediction mode for each of the coding units having the tree structure, and the inverse transformation unit 540 determines a size of a transformation unit for each coding unit.

FIG. 17 illustrates a depth-based coding unit and a partition according to an embodiment of the present invention.

The video encoding apparatus 100 according to an embodiment and the video decoding apparatus 200 according to an embodiment use a hierarchical coding unit for considering a characteristic of a video. A maximum height, a maximum width, and a maximum depth of a coding unit may be adaptively determined based on a characteristic of a video, and may be variously set according to a user's request. A size of a depth-based coding unit may be determined based on a predetermined maximum size of a coding unit.

In a layer structure 600 of a coding unit according to an embodiment, a case in which a maximum height and a maximum width of a coding unit are 64 and a maximum depth is 4 is illustrated. In this case, the maximum depth represents the total number of divisions from a maximum coding unit to a minimum coding unit. A depth is deepened along a height axis of the layer structure 600 of the coding unit according to an embodiment, and thus, a height and a width of a depth-based coding unit are each divided. Also, a prediction unit and a partition which are based on prediction encoding of each depth-based coding unit are illustrated along a width axis of the layer structure 600 of the coding unit.

That is, a coding unit 610 in which a depth is 0 and a size (i.e., a height and a width) of a coding unit is 64×64 is a maximum coding unit in the layer structure 600 of the coding unit. There are a coding unit 620 in which a size is 32×32 and a depth is 1, a coding unit 630 in which a size is 16×16 and a depth is 2, a coding unit 640 in which a size is 8×8 and a depth is 3, and a coding unit 650 in which a size is 4×4 and a depth is 4. The depth of each of the coding units 610 to 650 is deepened along a height axis. The coding unit 650, in which a size is 4×4 and a depth is 4, is a minimum coding unit.

A prediction unit and partitions of a coding unit are arranged long a width axis by depth. That is, when the coding unit 610 in which the depth is 0 and the size of the coding unit is 64×64 is a prediction unit, the prediction unit may be divided into a partition 610 of a size “64×64”, partitions 612 of a size “64×32”, partitions 614 of a size “32×64”, and partitions 616 of a size “32×32”, which are included in the coding unit 610 of a size “64×64”.

Similarly, a prediction unit of the coding unit 620 in which the size is 32×32 and the depth is 1 may be divided into a partition 620 of a size “32×32”, partitions 622 of a size “64×32”, partitions 624 of a size “16×32”, and partitions 626 of a size “16×16”, which are included in the coding unit 620 of a size “32×32”.

Similarly, a prediction unit of the coding unit 630 in which a size is 16×16 and a depth is 2 may be divided into a partition 630 of a size “16×16”, partitions 632 of a size “16×8”, partitions 634 of a size “8×16”, and partitions 636 of a size “8×8”, which are included in the coding unit 630 of a size “16×16”.

Similarly, a prediction unit of the coding unit 640 in which a size is 8×8 and a depth is 3 may be divided into a partition 640 of a size “8×8”, partitions 642 of a size “8×4”, partitions 644 of a size “4×8”, and partitions 646 of a size “4×4”, which are included in the coding unit 630 of a size “8×8”.

Finally, the coding unit 650 in which a size is 4×4 and a depth is 4 is a minimum coding unit, and is a coding unit of a lowermost depth, and a prediction unit of the coding unit 650 may be set by using only a partition 650 of a size “4×4”.

The coding unit determining unit 120 of the video encoding apparatus 100 according to an embodiment should perform coding per coding unit of each depth included in the maximum coding unit 610, for determining a coding depth of the maximum coding unit 610.

The number of depth-based coding units, into which data having the same range and size is added, increases as a depth becomes deeper. For example, in data including one coding unit of a depth “1”, four coding units of a depth “2” are needed. Therefore, in order to compare encoding results of the same data by depth, coding should be performed by using one coding unit of a depth “1” and four coding units of a depth “2”.

In order to perform coding by depth, a representative encoding error that is the smallest encoding error in a corresponding depth may be selected by performing coding per prediction units of a depth-based coding unit along the width axis of the layer structure 600 of the coding unit. Also, a depth is deepened along the height axis of the layer structure 600 of the coding unit, and a minimum encoding error may be searched by performing coding per depth to compare representative encoding errors by depth. A depth and a partition in which a minimum encoding error occurs in the maximum coding unit 610 may be selected as a coding depth and a partition type of the maximum coding unit 610.

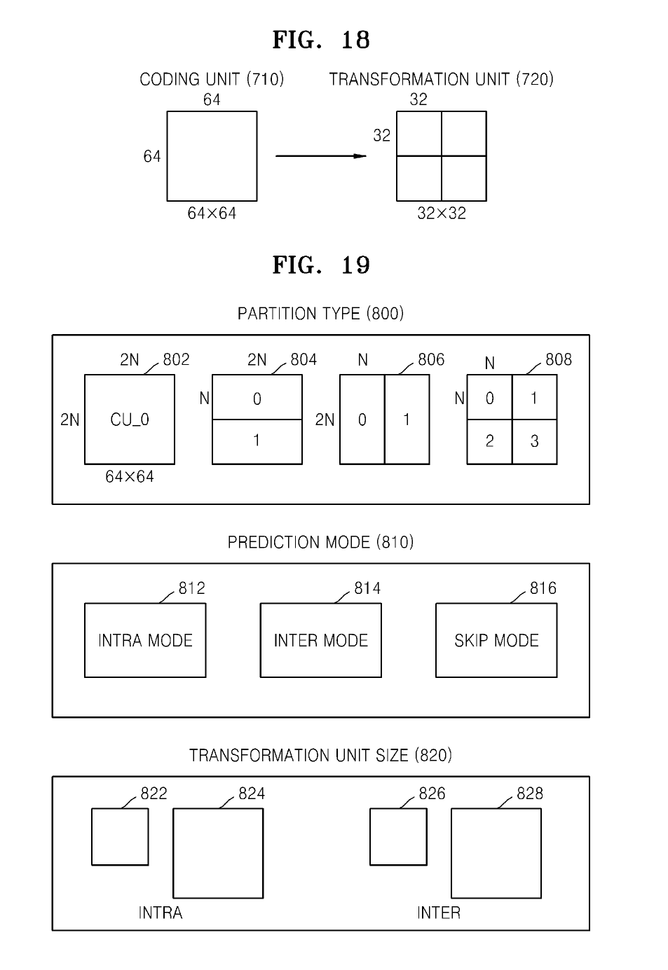

FIG. 18 illustrates a relationship between a coding unit and a transformation unit, according to an embodiment of the present invention.

The video encoding apparatus 100 according to an embodiment or the video decoding apparatus 200 according to an embodiment encodes or decodes a video by a coding unit having a size equal to or less than that of a maximum coding unit per maximum. In an encoding operation, a size of a transformation unit for transformation may be selected based on a data unit which is not greater than each coding unit.

For example, in the video encoding apparatus 100 according to an embodiment or the video decoding apparatus 200 according to an embodiment, when a current coding unit 710 has a size “64×64”, transformation may be performed by using a transformation unit 720 of a size “32×32”.

Moreover, data of a coding unit 710 having a size “64×64” may be converted by transformation units having sizes of 32×32, 16×16, 8×8, and 4×4 equal to or less than a size “64×64” to thereby be decoded, and then, a transformation unit in which an error with the original is smallest may be selected.

FIG. 19 illustrates pieces of depth-based encoding information according to an embodiment of the present invention.

The output unit 130 of the video encoding apparatus 100 according to an embodiment may decode and transmit, as information about an encoding mode, information 800 about a partition type, information 810 about a prediction mode, and information 820 about a transformation unit size for each coding unit of each coding depth.

The information 800 about the partition type is a data unit for predictive encoding of a current coding unit, and represents information about types of partitions into which a prediction unit of the current coding unit is divided. For example, a current coding unit CU_{—}0 of a size “2N×2N” may be divided into one type selected from a partition 802 of a size “2N×2N”, a partition 804 of a size “2N×N”, a partition 806 of a size “N×2N”, and a partition 808 of a size “N×N”, and may be used. In this case, the information 800 about the partition type of the current coding unit is set to represent one selected from the partition 802 of a size “2N×2N”, the partition 804 of a size “2N×N”, the partition 806 of a size “N×2N”, and the partition 808 of a size “N×N”.

The information 810 about the prediction mode represents a prediction mode of each partition. For example, by using the information 810 about the prediction mode, whether predictive encoding of a partition indicated by the information 800 about the partition type is performed in one selected from an intra mode 812, an inter mode 814, and a skip mode 816 may be set.

Moreover, the information 820 about the transformation unit size represents what transformation unit the current coding unit is converted based on. For example, a transformation unit may be one selected from a first intra transformation unit size 822, a second intra transformation unit size 824, a first inter transformation unit size 826, and a second intra transformation unit size 828.

The video data and decoding information extracting unit 220 of the video decoding apparatus 200 according to an embodiment may extract the information 800 about the partition type, the information 810 about the prediction mode, and the information 820 about the transformation unit size per depth-based coding unit, and use the extracted information for decoding.

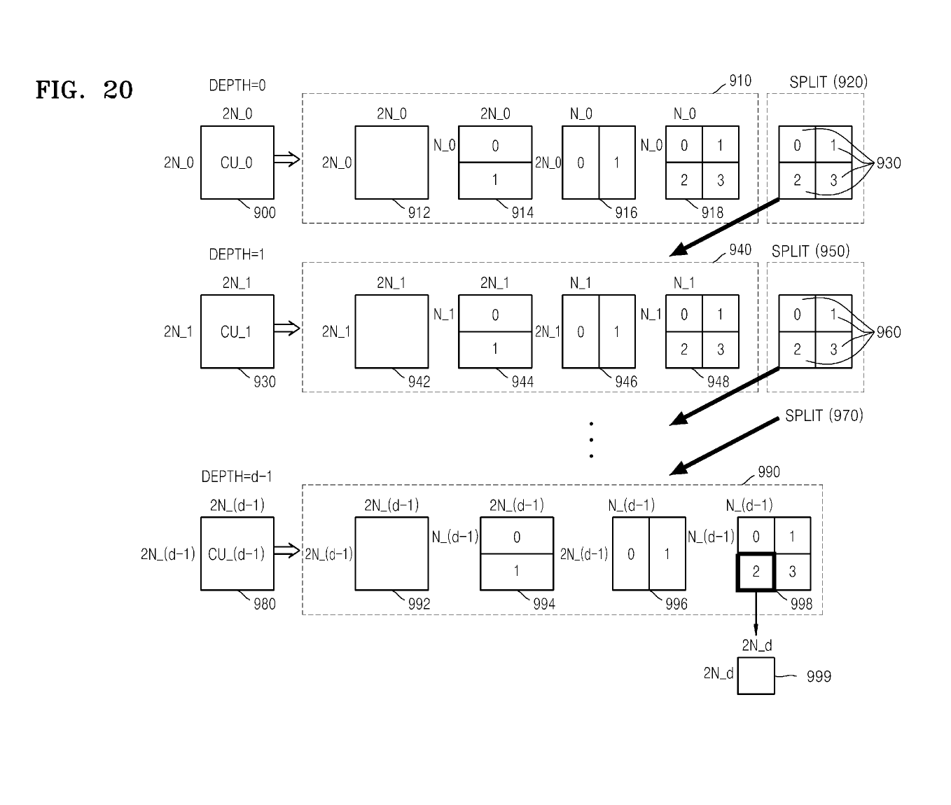

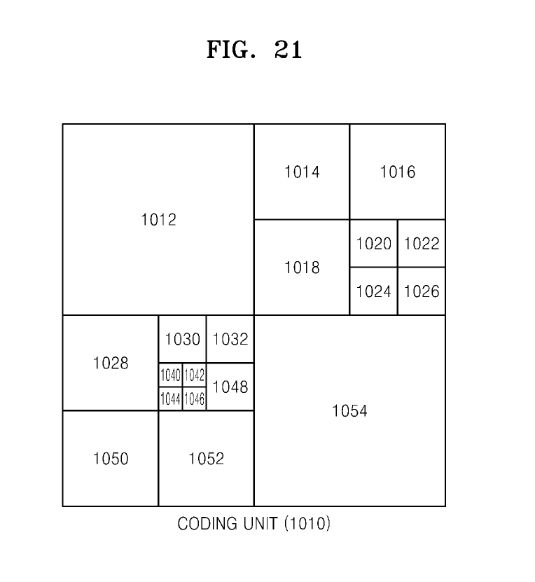

FIG. 20 illustrates a depth-based coding unit according to an embodiment of the present invention.

Division information may be used for representing transformation of a depth. The division information represents whether a coding unit of a current depth is divided into a coding unit of a lower depth.

A prediction unit 910 for predictive encoding of a coding unit 900 having a depth “0” and a size “2N_{—}0×2N_{—}0” may include a partition type 912 of a size “2N_{—}0×2N_{—}0”, a partition type 914 of a size “2N_{—}0×N_{—}0”, a partition type 916 of a size “N_{—}0×2N_{—}0”, and a partition type 918 of a size “N_{—}0×N_{—}0”. Only the partitions 912, 914, 916 and 918 into which a prediction unit is divided at a symmetric ratio are exemplified, but a partition type is not limited thereto. As described above, examples of the partition type may include an asymmetric partition, an arbitrary type of partition, and a geometric type of partition.

Predictive encoding should be repeatedly performed per partition type, for example, per one partition type of a size “2N_{—}0×2N_{—}0”, two partition types of a size “2N_{—}0×N_{—}0”, three partition types of a size “N_{—}0×2N_{—}0”, and four partition types of a size “N_{—}0×N_{—}0”. Predictive encoding may be performed for partitions of a size “2N_{—}0×2N_{—}0”, a size “2N_{—}0×N_{—}0”, a size “N_{—}0×2N_{—}0”, and a size “N_{—}0×N_{—}0” in the intra mode and the inter mode. Predictive encoding may be performed for the partition of a size “2N_{—}0×2N_{—}0” in the skip mode.

When an encoding error caused by one of the partition types 912, 914 and 916 of sizes “2N_{—}0×2N_{—}0”, “2N_{—}0×N_{—}0”, and “N_{—}0×2N_{—}0” is smallest, division to a lower depth is no longer required.

When an encoding error caused by the partition type 918 of a size “N_{—}0×N_{—}0” is smallest, a depth is changed from 0 to 1 and is divided (920), and a minimum encoding error may be searched by repeatedly performing coding on a plurality of coding units 930 having a partition type having a depth “2” and a size “N_{—}0×N_{—}0”.

A prediction unit 940 for predictive encoding of an coding unit 930 having a depth “1” and a size “2N_{—}1×2N_{—}1 (=N_{—}0×N_{—}0)” may include a partition type 942 of a size “2N_{—}1×2N_{—}1”, a partition type 944 of a size “2N_{—}1×N_{—}1”, a partition type 946 of a size “N_{—}1×2N_{—}1”, and a partition type 948 of a size “N_{—}1×N_{—}1”.

When an encoding error caused by the partition type 948 of a size “N_{—}1×N_{—}1” is smallest, a depth is changed from 1 to 2 and is divided (950), and a minimum encoding error may be searched by repeatedly performing coding on a plurality of coding units 960 having a partition type having a depth “2” and a size “N_{—}2×N_{—}2”. When a maximum depth is d, a depth-based coding unit is set up to a depth “d−1”, and division information may be set up to a depth “d−2”. That is, when division is performed from the depth “d−2” (970) and encoding is performed up to the depth “d−1”, a prediction unit 990 for predictive encoding of a coding unit 980 having a depth “d−1” and a size “2N_(d−1)×2N_(d−1)” may include a partition type 992 of a size “2N_(d−1)×2N_(d−1)”, a partition type 994 of a size “2N_(d−1)×N_(d−1)”, a partition type 996 of a size “N_(d−1)×2N_(d−1)”, and a partition type 998 of a size “N_(d−1)×N_(d−1)”.

Coding may be performed by repeatedly performing predictive encoding per one partition of a size “2N_(d−1)×2N_(d−1)”, two partitions of a size “2N_(d−1)×N_(d−1)”, three partitions of a size “N_(d−1)×2N_(d−1)”, and four partitions of a size “N_(d−1)×N_(d−1)”, and thus, a partition type in which a minimum encoding error occurs may be searched.

Even when an encoding error caused by the partition type of a size “N_(d−1)×N_(d−1)” is smallest, since a maximum depth is d, a coding unit CU_(d−1) of a depth “d−1” does no longer undergo division to a lower depth, a coding depth for a current maximum coding unit 900 is determined as a depth “d−1”, and a partition type is determined as “N_(d−1)×N_(d−1)”. Also, since a maximum depth is d, division information is not set for a coding unit 952 of a depth “d−1”.

A data unit 999 may be referred to as a minimum unit for a current maximum coding unit. The minimum unit according to an embodiment may be a square data unit having a size of when a minimum coding unit that is a lowermost coding depth is divided by four. Through such repetitive encoding operation, the video encoding apparatus 100 according to an embodiment may compare encoding errors by depth of the coding unit 900 to select a depth in which a smallest encoding error occurs, determine a coding depth, and set a corresponding partition type and a prediction mode to an encoding mode of a coding depth.

In this way, a depth in which an error is smallest may be selected by comparing all minimum encoding errors by depth of depths “0, 1, . . . , d−1”, and may be determined as a coding depth. A coding depth and a prediction mode and partition type of a prediction unit are information about an encoding mode, and may be encoded and transmitted. Also, since a coding unit should be divided from a depth “0” to a coding depth, only division information of the coding depth is set to 0, and depth-based division information except the coding depth is set to 1.

The video data and decoding information extracting unit 220 of the video decoding apparatus 200 according to an embodiment may extract information about a coding depth and a prediction unit for the coding unit 900, and use the extracted information in decoding the coding unit 912. The video decoding apparatus 200 according to an embodiment may determine, as a coding depth, a depth in which division information is 0 by using the depth-based division information, and perform decoding by using information about an encoding mode for a corresponding depth.

FIGS. 21 to 23 illustrate a relationship between a coding unit, a prediction unit, and a transformation unit, according to an embodiment of the present invention.

A coding unit 1010 includes a plurality of coding depth-based coding units determined by the video encoding apparatus 100 according to an embodiment for a maximum coding unit. A prediction unit 1060 includes partitions of prediction units of the coding depth-based coding units included in the coding unit 1010, and a transformation unit 1070 includes transformation units of the coding depth-based coding units.

In the depth-based coding units 1010, when a depth of the maximum coding unit is 0, a plurality of coding units 1012 and 1054 have a depth “1”, a plurality of coding units 1014, 1016, 1018, 1028, 1050 and 1052 have a depth “2”, a plurality of coding units 1020, 1022, 1024, 1026, 1030, 1032 and 1048 have a depth “3”, and a plurality of coding units 1040, 1042, 1044 and 1046 have a depth “4”.

Some partitions 1014, 1016, 1022, 1032, 1048, 1050, 1052 and 1054 of the prediction units 1060 have a type in which a coding unit is divided. That is, the partitions 1014, 1022, 1050 and 1054 have a partition type of 2N×N, the partitions 1016, 1048 and 1052 have a partition type of N×2N, and the partition 1032 have a partition type of N×N. The prediction unit and partitions of the depth-based coding units 1010 are equal to or less than those of each coding unit.

Transformation or inverse transformation of video data of some 1052 of the transformation units 1070 is performed by a data unit having a smaller size than that of the coding unit. Comparing with a corresponding prediction unit and partition among the prediction units 1060, transformation units 1014, 1016, 1022, 1032, 1048, 1050, 1052 and 1054 are data units having different sizes or types. That is, the video encoding apparatus 100 according to an embodiment and the video decoding apparatus 200 according to an embodiment may perform an intra prediction/motion estimation/motion compensation operation and a transformation/inverse transformation operation for the same coding unit, based on different data units.

Therefore, an optimal coding unit is determined by recursively performing coding for each of coding units having a hierarchical structure by region per a maximum coding unit, and thus, a plurality of coding units based on a recursive tree structure may be constructed. Encoding information may include division information, partition type information, prediction mode information, and transformation unit size information for a coding unit. Table 2 shows an example which may be set in the video encoding apparatus 100 according to an embodiment and the video decoding apparatus 200 according to an embodiment.

TABLE 2

| Division information 0 | | | | | Division |
|---|---|---|---|---|---|
| (encoding for a coding unit of a current depth “d” and a size “2N × 2N”) | | | | | information 1 |
| Prediction | Partition type | | Transformation unit size | | Repetitive |
| mode | | | | | encoding per |
| Intra | Symmetric | Asymmetric | Transformation | Transformation | coding |
| Inter | partition | partition | unit Split | unit Split | units |
| Skip | type | type | information 0 | information 1 | of a |
| (only | 2N × 2N | 2N × nU | 2N × 2N | N × N | lower depth |
| 2N × 2N) | 2N × N | 2N × nD | | (symmetric | “d + 1” |
| | N × 2N | nL × 2N | | partition type) | |
| | N × N | nR × 2N | | N/2 × N/2 | |
| | | | | (asymmetric | |
| | | | | partition type) | |

The output unit 130 of the video encoding apparatus 100 according to an embodiment outputs encoding information about coding units based on a tree structure, and the video data and decoding information extracting unit 220 of the video decoding apparatus 200 according to an embodiment may extract, from a received bitstream, the encoding information about the coding units based on the tree structure.

The division information represents whether a current coding unit is divided into coding units of a lower depth. When division information of a current depth “d” is 0, since a depth in which the current coding unit is no longer divided into a lower coding unit is a coding depth, partition type information, a prediction mode, and transformation unit size information may be defined for the coding depth. When division should be performed by one stage according to the division information, coding should be independently performed per four divided coding units of a lower depth.

The prediction mode may be represented as one selected from the intra mode, the inter mode, and the skip mode. The intra mode and the inter mode may be defined in all partition types. The skip mode may be defined in only a partition type “2N×2N”.

The partition type information may represent a plurality of symmetric partition types “2N×2N, 2N×N, N×2N, and N×N”, in which a height or a width of the prediction unit is divided at a symmetric ratio, and a plurality of asymmetric partition types “2N×nU, 2N×nD, nL×2N, and nR×2N” in which a height or a width of the prediction unit is divided at an asymmetric ratio. Each of the asymmetric partition types “2N×nU and 2N×nD” represents a type in which a height is divided at 1:3 and 3:1, and each of the asymmetric partition types “nL×2N, and nR×2N” represents a type in which a width is divided at 1:3 and 3:1.

The transformation unit size may be set to two types of sizes in the intra mode, and may be set to two types of sizes in the inter mode. That is, when the transformation unit division information is 0, a size of the transformation unit is set to a size “2N×2N” of the current coding unit. When the transformation unit division information is 1, a transformation unit having a size of when the current coding unit is divided may be set. Also, when a partition type of the current coding unit having a size “2N×2N” is a symmetric partition type, a size of the transformation unit may be set to “N×N”, and when the partition type of the current coding unit having a size “2N×2N” is an asymmetric partition type, the size of the transformation unit may be set to “N/2×N/2”.

Encoding information of coding units based on a tree structure according to an embodiment may correspond to at least one selected from a coding unit, a prediction unit, and a minimum unit of a coding depth. A coding unit of the coding depth may include one or more minimum units and prediction units retaining the same encoding information.

Therefore, when pieces of information retained by adjacent data units are checked, whether the information is included in a coding unit of the same coding depth may be checked. Also, a coding unit of a corresponding coding depth may be checked by using encoding information retained by a data unit, and thus, a distribution of coding depths in a maximum coding unit may analogized.

Therefore, in this case, when predictive encoding of the current coding unit is performed with reference to a peripheral data unit, encoding information of a data unit in a depth-based coding unit adjacent to the current coding unit may be directly referenced and used.

According another embodiment, when predictive encoding of the current coding unit is performed with reference to a peripheral coding unit, by using encoding information of an adjacent depth-based coding unit, data adjacent to the current coding unit in the depth-based coding unit may be searched, and thus, a peripheral coding unit may be referenced.

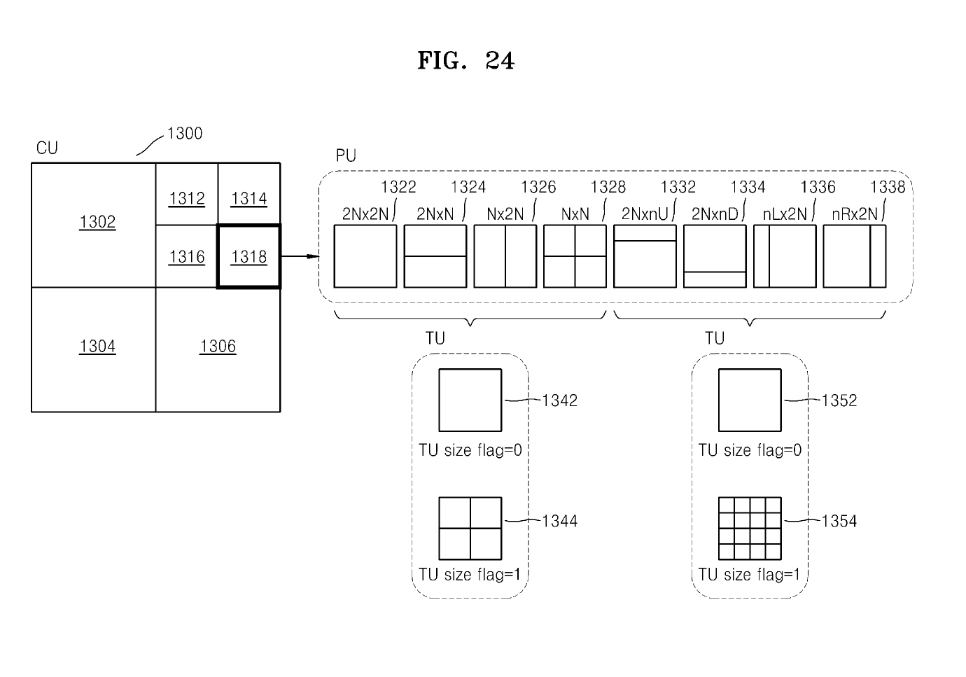

FIG. 24 illustrates a relationship between a coding unit, a prediction unit, and a transformation unit, based on encoding mode information of Table 2.

A maximum coding unit 1300 includes a plurality of coding units 1302, 1304, 1306, 1312, 1314, 1316 and 1318 of a coding depth. The coding unit 1318 is a coding unit of the coding depth, and thus, division information may be set to 0. Partition type information of the coding unit 1318 having a size “2N×2N” may be set to one of a plurality of partition types “2N×2N (1322), 2N×N (1324), N×2N (1326), N×N (1328), 2N×nU (1332), 2N×nD (1334), nL×2N (1336), and nR×2N (1338)”.

Transformation unit division information (TU size flag) is a type of transformation index, and a size of a transformation unit corresponding to the transformation index may be changed according to a prediction unit type or a partition type of a coding unit.

For example, in a case where partition type information is set to one of pieces of symmetric partition types “2N×2N (1322), 2N×N (1324), N×2N (1326), and N×N (1328)”, when the transformation unit division information is 0, a transformation unit 1342 of a size “2N×2N” may be set, and when the transformation unit division information is 1, a transformation unit 1344 of a size “N×N” may be set.

In a case where the partition type information is set to one of pieces of asymmetric partition types “2N×nU (1332), 2N×nD (1334), nL×2N (1336), and nR×2N (1338)”, when the transformation unit division information is 0, a transformation unit 1352 of a size “2N×2N” may be set, and when the transformation unit division information is 1, a transformation unit 1354 of a size “N/2×N/2” may be set.

It may be construed by one of ordinary skill in the art that block diagrams disclosed herein conceptually express a circuit for implementing the principles of the present invention. Similarly, it may be recognized by one of ordinary skill in the art an arbitrary flowchart, a state transition diagram, and a pseudo-code are actually expressed in a computer-readable medium, and represent various processes executable by a computer or a processor irrespective of that the computer or the processor is explicitly illustrated or not. Therefore, the above-described embodiments of the present invention may be written as computer programs and may be implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), etc), and transmission media such as Internet transmission media.

Functions of various elements illustrated in the drawings may be provided through the use of dedicated hardware as well as hardware capable of executing software in association with appropriate software. When the functions are provided by a processor, the functions may be provided by a single dedicated processor, a single shared processor, or a plurality of individual processors of which some are sharable. Also, it should not be construed that the explicit use of the term “processor” or “control unit” exclusively designates hardware capable of executing software, and the term “processor” or “control unit” may include digital signal processor (DSP) hardware, a read-only memory (ROM) for storing software, a random access memory (RAM), and a nonvolatile storage device without limitation.

In claims of the specification, an element expressed as a means for performing a specific function includes an arbitrary method of performing a specific function, and may include a combination of circuit elements performing a specific function or arbitrary type software including a firmware or a microcode combined with a circuit suitable for performing software for performing a specific function.

In the specification, ‘an embodiment’ of the principles of the present invention and designation of various modifications of the expression denote that a specific feature, structure, and characteristic are included in at least one embodiment of the principle of the present invention. Therefore, the expression ‘in an embodiment’ and arbitrary other modification examples disclosed herein do not necessarily refer to the same embodiment.

Herein, the expression ‘at least one of˜’ in the case of ‘at least one of A and B’ is used for only selection of a first option (A), for only selection of a second option (B), or for selection both options (A and B). As an additional example, a case of ‘at least one of A, B, and C’ may include only selection of a first listed option (A), only selection of a second listed option (B), only selection of a third listed option (C), only selection of first and second listed options (A and B), only selection of second and third listed options (B and C), or selection of all three options (A, B, and C). Even when more items are listed, interpretation can be expanded by those skilled in the art.

While this invention has been particularly shown and described with reference to preferred embodiments thereof.

It should be understood that the exemplary embodiments described therein should be considered in a descriptive sense only and not for purposes of limitation. Descriptions of features or aspects within each embodiment should typically be considered as available for other similar features or aspects in other embodiments. While one or more embodiments of the present invention have been described with reference to the figures, it will be understood by those of ordinary skill in the art that various changes in form and details may be made therein without departing from the spirit and scope of the present invention as defined by the following claims.

1. A scalable video encoding method comprising:
encoding a video according to at least one of a plurality of scalable extension types to generate a bitstream; and
adding scalable extension type information, representing a scalable extension type of the encoded video, into the bitstream,
wherein the scalable extension type information includes table index information, representing one of a plurality of scalable extension type information tables in which available combinations of a plurality of scalable extension types are specified, and layer index information representing the scalable extension type of the encoded video among combinations of a plurality of scalable extension types included in a scalable extension type information table.

2. The scalable video encoding method of claim 1, wherein the plurality of scalable extension types comprise at least one selected from spatial scalable extension, temporal scalable extension, quality scalable extension, and multiview scalable extension.

3. The scalable video encoding method of claim 1, wherein the scalable extension type information is added into a reserved network abstraction layer unit in a network abstraction layer, and is transmitted.

4. The scalable video encoding method of claim 1, wherein the scalable extension type information table is previously specified in a video encoding apparatus and a video decoding apparatus, or is transmitted from the video encoding apparatus to the video decoding apparatus by using one selected from sequence parameter set (SPS), picture parameter set (PPS), and supplemental enhancement information (SEI) messages.

5. A scalable video encoding method comprising:
encoding a video according to at least one of a plurality of scalable extension types to generate a bitstream; and
adding scalable extension type information, representing a scalable extension type of the encoded video, into the bitstream,
wherein,
the scalable extension type information includes combination scalable index information and pieces of sub-layer index information,
the combination scalable index information represents which of a plurality of scalable extension layers the pieces of sub-layer index information are mapped to, and
each of the pieces of sub-layer index information represents a specific scalable extension type of the encoded video.

6. The scalable video encoding method of claim 5, wherein the plurality of scalable extension types comprise at least one selected from spatial scalable extension, temporal scalable extension, quality scalable extension, and multiview scalable extension.

7. The scalable video encoding method of claim 5, wherein the scalable extension type information table is previously specified in a video encoding apparatus and a video decoding apparatus, or is transmitted from the video encoding apparatus to the video decoding apparatus by using one selected from sequence parameter set (SPS), picture parameter set (PPS), and supplemental enhancement information (SEI) messages.

8. A scalable video decoding method comprising:
receiving and parsing a bitstream of an encoded video to obtain a scalable extension type of the encoded video among a plurality of scalable extension types; and
decoding the encoded video, based on the obtained scalable extension type,
wherein the scalable extension type information includes table index information, representing one of a plurality of scalable extension type information tables in which available combinations of a plurality of scalable extension types are specified, and layer index information representing the scalable extension type of the encoded video among combinations of a plurality of scalable extension types included in a scalable extension type information table.

9. The scalable video decoding method of claim 8, wherein the plurality of scalable extension types comprise at least one selected from spatial scalable extension, temporal scalable extension, quality scalable extension, and multiview scalable extension.

10. The scalable video decoding method of claim 8, wherein the scalable extension type information is added into a reserved network abstraction layer unit in a network abstraction layer, and is transmitted.

11. The scalable video decoding method of claim 8, wherein the scalable extension type information table is previously specified in a video encoding apparatus and a video decoding apparatus, or is transmitted from the video encoding apparatus to the video decoding apparatus by using one selected from sequence parameter set (SPS), picture parameter set (PPS), and supplemental enhancement information (SEI) messages.

12. A scalable video decoding method comprising:
receiving and parsing a bitstream of an encoded video to obtain a scalable extension type of the encoded video among a plurality of scalable extension types; and
decoding the encoded video, based on the obtained scalable extension type,
wherein,
the scalable extension type information includes combination scalable index information and pieces of sub-layer index information,
the combination scalable index information represents which of a plurality of scalable extension layers the pieces of sub-layer index information are mapped to, and
each of the pieces of sub-layer index information represents a specific scalable extension type of the encoded video.

13. The scalable video decoding method of claim 12, wherein the plurality of scalable extension types comprise at least one selected from spatial scalable extension, temporal scalable extension, quality scalable extension, and multiview scalable extension.

14. The scalable video decoding method of claim 12, wherein the scalable extension type information is added into a reserved network abstraction layer unit in a network abstraction layer, and is transmitted.

15. The scalable video decoding method of claim 12, wherein the scalable extension type information table is previously specified in a video encoding apparatus and a video decoding apparatus, or is transmitted from the video encoding apparatus to the video decoding apparatus by using one selected from sequence parameter set (SPS), picture parameter set (PPS), and supplemental enhancement information (SEI) messages.
